(19) United States
(12) Patent Application Publication
(10) Pub. No.: US 2024/0249168 A1
(43) Pub. Date: Jul. 25, 2024

(54) SYSTEM FOR PROBABILISTIC MODELING AND MULTI-LAYER MODELING FOR DIGITAL TWINS

(71) Applicant: Accenture Global Solutions Limited, Dublin 4 (IE)

(72) Inventors: Neda Abolhassani, San Mateo, CA (US); Hayden Freedman, Laguna Beach, CA (US); Jacob Charles Metzger, San Francisco, CA (US); Sanjoy Paul, Sugar Land, TX (US)

(21) Appl. No.: 18/101,579

(22) Filed: Jan. 25, 2023

(51) Int. Cl. G06N 7/01; G06N 5/022

(52) U.S. Cl. CPC G06N 7/01; G06N 5/022

(57) ABSTRACT

Aspects of the present disclosure provide systems, methods, and computer-readable storage media that support ontology driven processes to generate digital twins using a partially automated process. To generate the digital twin, an ontology may be obtained and used to generate a multi-layer probabilistic knowledge graph as a digital twin. A first layer may include a domain ontology knowledge graph that is generated based on the ontology. A second layer may include a probabilistic ontology graph model that is automatically generated based on the domain ontology knowledge graph. A third layer may include a decision optimization model that represents decisions that optimize variable(s) included in the second layer. The digital twin based on this multi-layer probabilistic knowledge graph may enable improved querying of semantic information, probability distributions, and decision information from a single model without requiring a user to be trained in probability theory to set up the digital twin.

### TECHNICAL FIELD

The present disclosure relates generally to system modelling and more specifically to techniques for extending capabilities of digital twins using probabilistic reasoning domain ontology mapping.

### BACKGROUND

Presently, entities across many different industries are seeking to incorporate the use of digital twins to test, streamline, or otherwise evaluate various aspects of their operations. One such industry is the automotive industry, where digital twins has been explored as a means to analyze and evaluate performance of a vehicle. To illustrate, the use of digital twins has been explored as a means to safely evaluate performance of autonomous vehicles in mixed driver environments (i.e., environments where autonomous vehicles are operating in the vicinity of human drivers). As can be appreciated from the non-limiting example(s) above, the ability to analyze performance or other factors of a system or process using a digital twin, rather than its real world counterpart (e.g., the vehicle represented by the digital twin), can provide significant advantages. Although the use of digital twins has proven useful across many different industries, much of the current interest is focused on the benefits that may be realized by using digital twins, and other challenges have gone unaddressed.

One particular challenge that remains with respect to the use of digital twins is the creation of the digital twins themselves. For example, tools currently exist to aid in the creation of digital twins, but most existing tools are limited in the sense that they may be suitable for a specific use case (e.g., creating a digital twin of a physical space, such as a building) but not suitable for other use cases (e.g., creating a digital twin of a process). Additionally, an entity may offer a digital twin platform specific to systems, products, or services of the entity, but such digital twin platforms may not be capable of being utilized for other systems, products, or service (i.e., the digital twin platform is only compatible with the entity's system(s), products, services, etc.). Furthermore, such entity-specific digital twins are not capable of being modified or customized by users, thereby limiting the information that may be obtained from the digital twin to those use cases approved or created by the entity, rather than the ultimate end users of the digital twin platform.

As a result, users of digital twins may seek to utilize multiple tools to develop digital twins covering different portions of a use case of interest. In such instances additional challenges may occur, such as digital twins created using different tools being incompatible with each other, thereby limiting the types of analysis and insights that may be obtained using the digital twins. Additionally, some digital twin creation tools are not well-suited with respect to addressing changes to the real world counterpart and may require re-designing and rebuilding the digital twin each time changes to the real world counterpart occur. This can be particularly problematic for uses cases involving industries where changes frequently occur, such as the manufacturing industry. An additional challenge that occurs when creating digital twins is that existing platforms or tools for creating digital twins do not support customization of the types of information that can be used with the digital twin, thereby limiting the ability to create a digital twin that utilizes information that allows meaningful evaluation of a use case of interest. For example, it can be difficult to use statically designed digital twin creation tools (i.e., digital twin tools designed for a specific use case or real world counterpart) with certain types of information, such as time series information or a new use case. This is because static digital twin design tools and platforms are designed to create digital twins for a specific use case or real world counterpart with data defined a priori and such tools do not enable customization of the digital twin to reflect changes to the use case or real world counterpart for which the tools or platforms were designed. Another challenge is scaling of digital twins. For example, a digital twin may describe a set of data that may be used for evaluation purposes, but the dataset may be limited in size or limited in the data structure complexity and may not support the ability to incorporate new more complex types of information, such as time-series data or hierarchical data.

Some digital twins may leverage certain types of ontological reasoning in an attempt to provide decision support systems, such as knowledge graphs. An ontology may allow domain-specific data to be represented in knowledge graphs, but knowledge graphs typically represent data in an absolute way and do not support reasoning under uncertain conditions. Additionally, although knowledge graphs provide semantic expressiveness in modelling domain-specific data, the insights provided by a knowledge graph are insufficient to provide probabilistic reasoning capabilities. Thus, relationships may be derived from data of past events, but uncertain future events are not capable of being probabilistically modelled, limiting the usefulness of a corresponding digital twin in predicting future data related to its real world counterpart. Thus, while digital twins have shown promise as a tool for evaluating real world designs, the above-described drawbacks have limited the benefits that may be realized by using digital twins.

### SUMMARY

Aspects of the present disclosure provide systems, methods, and computer-readable storage media that support ontology-driven modeling processes and tools to generate digital twins with extended capabilities. The disclosed processes for generating digital twins may start by obtaining an ontology representing a real world system, machine, process, workflow, organization, application, and the like. The ontology and domain data may be used to construct a digital twin, which may be represented as a multi-layer probabilistic knowledge graph. For example, the ontology may provide an explicit specification of concepts, properties, and relationships between different objects within the domain, that may be useful in generating at least one layer of the multi-layer probabilistic knowledge graph. In addition to the ontology, the compiled data may include other types of information, such as operational data (e.g., if the ontology describes a vehicle, the operational data may include data captured during operation of the vehicle), sensor data, measurement data, stored information, patient data, customer data, or the like.

The first layer of the multi-layer probabilistic knowledge graph may include a domain ontology knowledge graph having nodes connected by edges, where the edges represent semantic relationships between the nodes. Information may be inferred from the semantic relationships represented by the domain ontology knowledge graph, and such information is limited to logical inferences. As such, the knowledge that may be inferred from the knowledge graph is limited to explicit information presented in the graph, such as frequencies, counts, relationships, hierarchies, and the like. The second layer of the multi-layer probabilistic knowledge graph may include a probabilistic ontology graph model. The probabilistic ontology graph model may be automatically generated by converting the knowledge graph into a Bayesian network through use of a custom probabilistic ontology that models probabilistic representations of data. This automatic construction of the probabilistic ontology graph model does not require additional ontology modelling beyond an initial ontology about a data domain, thereby enabling generation of a probabilistic model without requiring input by someone with knowledge and experience in ontological modelling and probabilistic distribution modelling. The probabilistic ontology graph model may model random variables extracted from the domain ontology knowledge graph, each of the random variables being associated with a probability distribution, but upon initially determining the random variables, one or more parameters of the probability distributions may be unknown. Bayesian learning techniques may be used to learn the unknown parameters or approximations of those parameters from the data of the knowledge graph. The third layer of the multi-layer probabilistic knowledge graph may include a decision optimization model that is constructed based on the probability distributions. The decision optimization model represents decisions made based on an optimization of a set of variables from the probabilistic ontology graph model (e.g., a set of random variables). This third layer (e.g., the decision optimization model) contains the classes and properties used to model the process of decision optimization under uncertain conditions. Thus, the multi-layer probabilistic knowledge graph model creates a single layered model that, instead of keeping probabilistic distributions separate from a knowledge graph, integrates a domain ontology, a probabilistic ontology, and probability distributions that represent conditional dependencies between ontology classes. Such a layered integration enables queries to be constructed for concurrent access of the probabilistic graph and the domain ontology and its associated data, rather than accessing them separately or only accessing one for querying, and for query results that can include domain data, probabilistic distributions, and optimized decisions based on the probabilistic distributions. This enables a digital twin to be queried in a manner that optimization problems associated with the real world counterpart may be evaluated and solved (e.g., for the hospital site that most closely matches the provided target distribution, what are the identifiers for the female patients from the most underrepresented racial group at this site).

In a particular aspect, a method for creating digital twins includes obtaining, by one or more processors, a dataset. The dataset includes an ontology and domain data corresponding to a domain associated with the ontology. The method also includes generating, by the one or more processors, a multi-layer probabilistic knowledge graph based on the ontology and the domain data. The multi-layer probabilistic knowledge graph represents a digital twin of a real world counterpart. Generating the multi-layer probabilistic knowledge graph includes constructing a first layer of the multi-layer probabilistic knowledge graph based on the ontology and the domain data. The first layer includes a domain ontology knowledge graph that incorporates at least a portion of the domain data. Generating the multi-layer probabilistic knowledge graph also includes automatically constructing a second layer of the multi-layer probabilistic knowledge graph based on the first layer. The second layer includes a probabilistic ontology graph model that includes probability distributions for one or more variables. The method further includes running, by the one or more processors, a query against the first layer and the second layer to obtain a query result. The query result includes one or more portions of the domain data, one or more of the probability distributions, or a combination thereof.

In another particular aspect, a system for creating digital twins includes a memory and one or more processors communicatively coupled to the memory. The one or more processors are configured to obtain a dataset. The dataset includes an ontology and domain data corresponding to a domain associated with the ontology. The one or more processors are also configured to generate a multi-layer probabilistic knowledge graph based on the ontology and the domain data. The multi-layer probabilistic knowledge graph represents a digital twin of a real world counterpart. To generate the multi-layer probabilistic knowledge graph the one or more processors are configured to construct a first layer of the multi-layer probabilistic knowledge graph based on the ontology and the domain data. The first layer includes a domain ontology knowledge graph that incorporates at least a portion of the domain data. To generate the multi-layer probabilistic knowledge graph the one or more processors are also configured to automatically construct a second layer of the multi-layer probabilistic knowledge graph based on the first layer. The second layer includes a probabilistic ontology graph model that includes probability distributions for one or more variables. The one or more processors are further configured to run a query against the first layer and the second layer to obtain a query result. The query result includes one or more portions of the domain data, one or more of the probability distributions, or a combination thereof.

In another particular aspect, a non-transitory computer-readable storage medium stores instructions that, when executed by one or more processors, cause the one or more processors to perform operations for creating digital twins. The operations include obtaining a dataset, wherein the dataset comprises an ontology and domain data corresponding to a domain associated with the ontology. The operations also include generating a multi-layer probabilistic knowledge graph based on the ontology and the domain data. The multi-layer probabilistic knowledge graph represents a digital twin of a real world counterpart. Generating the multi-layer probabilistic knowledge graph includes constructing a first layer of the multi-layer probabilistic knowledge graph based on the ontology and the domain data. The first layer includes a domain ontology knowledge graph that incorporates at least a portion of the domain data. Generating the multi-layer probabilistic knowledge graph also includes automatically constructing a second layer of the multi-layer probabilistic knowledge graph based on the first layer. The second layer includes a probabilistic ontology graph model that includes probability distributions for one or more variables. The operations further include running a query against the first layer and the second layer to obtain a query result. The query result includes one or more portions of the domain data, one or more of the probability distributions, or a combination thereof.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports creation of digital twins according to one or more aspects of the present disclosure;

FIG. 2A is a block diagram of an example of a knowledge graph according to one or more aspects of the present disclosure;

FIG. 2B is a block diagram of another example of a knowledge graph according to one or more aspects of the present disclosure;

FIG. 2C is a block diagram of an example of a probabilistic graph model according to one or more aspects of the present disclosure;

FIG. 2D is a block diagram of another example of a probabilistic graph model according to one or more aspects of the present disclosure;

FIG. 3 is a diagram of an example of a multi-layer probabilistic knowledge graph according to one or more aspects of the present disclosure;

FIG. 4 is a block diagram of an example of a domain ontology knowledge graph according to one or more aspects of the present disclosure;

FIG. 5 is a block diagram of an example of a probabilistic ontology graph model according to one or more aspects of the present disclosure;

FIG. 6 is a block diagram of an example of a decision optimization model according to one or more aspects of the present disclosure; and

FIG. 7 is a flow diagram illustrating an example of a method for creating a digital twin according to one or more aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, and computer-readable storage media that support ontology-driven modeling processes and tools to generate multi-level probabilistic graph models that extend the capabilities of digital twins with respect to inferencing, prediction, decision making, and querying. The process of generating a multi-level probabilistic graph model leverages an ontology representing a real world system, machine, process, workflow, organization, application, and the like and domain data to construct a knowledge graph, and from the knowledge graph, automatically construct a probabilistic domain graph model that can be extended to include information about optimizing one or more decisions based on probability distributions. For example, the multi-level probabilistic graph model may include a domain knowledge graph as a first level, a probabilistic domain graph model as a second level, and an optimization model as a third level that integrates semantic inferences, probability distributions, and decision optimization into a single model. By integrating these various modelling techniques into a single model, a digital twin based on a multi-level probabilistic graph model supports improved queries that may provide results that enable evaluation and solving of optimization problems associated with the real world counterpart of the digital twin without querying multiple distinct models that may be slower and generate results that may not be able to be meaningfully combined in a way that supports evaluation and solving of the queried issues.

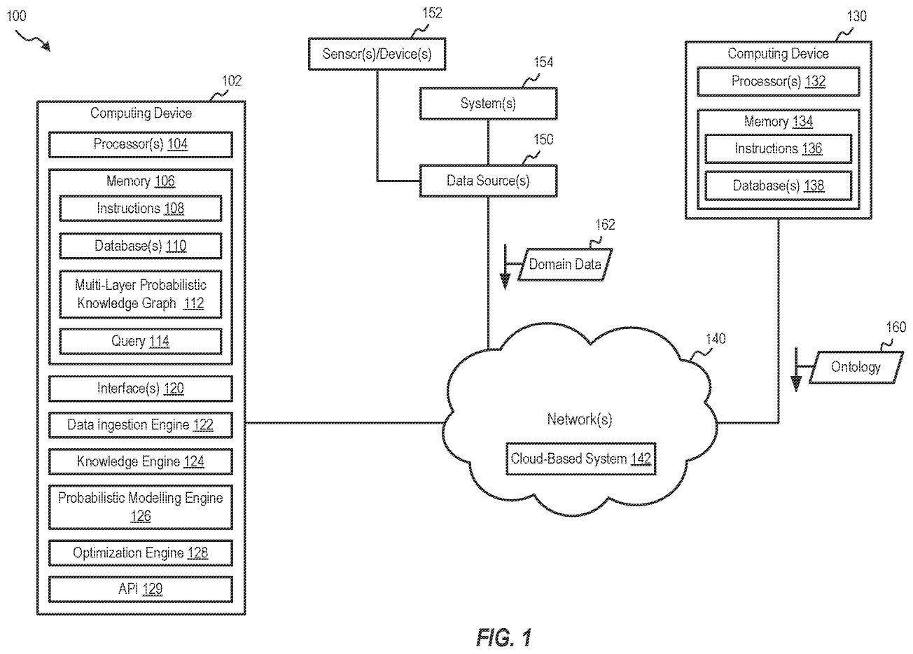

Referring to FIG. 1, an example of a system that supports generation of digital twins according to one or more aspects of the present disclosure is shown as a system 100. The system 100 may be configured to generate a digital twin of a real-world counterpart using a multi-layer. As shown in FIG. 1, the system 100 includes a computing device 102, another computing device 130, one or more data sources (referred to herein as “data sources 150”), one or more sensors and/or devices (referred to herein as “sensors/devices 152”), one or more systems (referred to herein as “systems 154”), and one or more networks 140. In some implementations, the system 100 may include more or fewer components than are shown in FIG. 1, such as additional computing devices, data sources, systems, or the like, or the computing device 130 may be omitted, as non-limiting examples.

The computing device 102 may include or correspond to a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The computing device 102 includes one or more processors 104, a memory 106, a data ingestion engine 122, a knowledge engine 124, a probabilistic modelling engine 126, an optimization engine 128, and one or more communication interfaces 120. In some implementations the computing device 102 may also provide one or more an application programming interface (API) 129 that enables interaction with the functionality described in connection with the computing device 102, as described in more detail below. In additional or alternative implementations the API 129 may be provided by another device of the system 100, such as computing device 130, as described in more detail below. In some other implementations, one or more of the components 122-128 may be optional, one or more of the components 122-128 may be integrated into a single component (e.g., the data ingestion engine 122 and the knowledge engine 124 may be combined, etc.), one or more additional components may be included in the computing device 102, or combinations thereof (e.g., some components may be combined into a single component, some components may be omitted, while other components may be added).

It is noted that functionalities described with reference to the computing device 102 are provided for purposes of illustration, rather than by way of limitation and that the exemplary functionalities described herein may be provided via other types of computing resource deployments. For example, in some implementations, computing resources and functionality described in connection with the computing device 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the computing device 102 may be performed by one or more servers or a cloud-based system 142 that communicates with one or more client or user devices.

The one or more processors 104 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the computing device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 102 may be stored in the memory 106 as instructions 108 that, when executed by the one or more processors 104, cause the one or more processors 104 to perform the operations described herein with respect to the computing device 102, as described in more detail below. Additionally, the memory 106 may be configured to store data and information in one or more databases 110, as well as a multi-layer probabilistic knowledge graph 112 and a query 114. Illustrative aspects of the one or more databases 110, the multi-layer probabilistic knowledge graph 112, and the query 114 are described in more detail below.

The one or more communication interfaces 120 may be configured to communicatively couple the computing device 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the computing device 102 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 102. In some implementations, the computing device 102 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the computing device 102.

The data ingestion engine 122 may be configured to provide functionality for collecting data to support the functionality provided by the computing device 102. For example, the data ingestion engine 122 may provide functionality for obtaining data to support the operations of the computing device 102 from one or more data sources. Exemplary types of data that may be obtained using the data ingestion engine 122 include one or more ontologies, domain data associated with one or more domains of the ontologies, data collected by Internet of Things (IoT) devices, infrastructure data, financial data, mapping data, time series data, SQL data, registration data, user data, patient data, medical records, or other types of data. The data obtained by the data ingestion engine 122 may be stored in the one or more databases 110 and used by the probabilistic modelling engine 126 to generate probabilistic models that enable observations, simulations, and other types of operations to be performed, as described in more detail below. Additionally or alternatively, the data obtained by the data ingestion engine 122 and/or the data stored in the one or more databases 110 may be used by the optimization engine 128 to make decisions to optimize or otherwise satisfy criteria for one or more variables associated with the probability distributions.

The ontologies obtained by the data ingestion engine 122 provide an abstracted representation of an entity that represents or defines concepts, properties, and relationships for the entity using an accepted body of knowledge (e.g., industry accepted terminology and semantics). The ontologies may specify object types and their semantic relationship to other object types via graph format. Exemplary formats in which the ontologies may be obtained by the data ingestion engine 122 include “.owl” and “.ttl,” files. As a non-limiting example, an ontology for a manufacturer may indicate the manufacturer has production facilities in one or more geographic locations and include, for each production facility, information representing: a floor plan for the production facility, manufacturing infrastructure present at the production facility (e.g., assembly robots, computing infrastructure, equipment, tools, and the like), locations of the manufacturing infrastructure within the production facility, other types of information, or combinations thereof. It is noted that while the exemplary characteristics of the above-described ontology have been described with reference to a manufacturer domain, the ontologies obtained by the data ingestion engine 122 may include ontologies representative of other types of domains, such as ontologies associated with processes (e.g., manufacturing processes, computing processes, biological processes, chemical processes, medical treatment processes, customer transaction management processes, etc.), ontologies associated with machinery or equipment (e.g., a vehicle, a computing device or component thereof, circuitry, robots, etc.), ontologies associated with biological systems, and the like. Accordingly, it should be understood that the operations disclosed herein with reference to the computing device 102 may be applied to any industry, process, machine, etc. capable of representation via an ontology.

The knowledge engine 124, the probabilistic modelling engine 126, and the optimization engine 128 provide functionality for generating a digital twin based on an ontology provided to the computing device 102 and data. For example, the computing device 130 may provide an ontology 160 to the computing device 102 and the ontology 160 may include information descriptive of a real world system, process, device, and the like, such as the systems 154, as a non-limiting example. The data may also include domain data 162 that corresponds to information obtained from the real world system, process, device, etc., such as operational data, configuration data, output data, performance data, and the like. For example, the domain data 162 may be received from the data sources 150, the sensors 152, and/or the systems 154. As described in more detail below, the knowledge engine 124, the probabilistic modelling engine 126, and the optimization engine 128 may generate a digital twin based on the ontology 160 and the domain data 162. For example, the knowledge engine 124, the probabilistic modelling engine 126, and the optimization engine 128 may provide functionality for creating a digital twin corresponding to the real world counterpart (e.g., the systems 154, in some examples) associated with the ontology 160.

As described in more detail below, the digital twin may be created by instantiating the ontology 160 as a multi-layer probabilistic knowledge graph 112. In some implementations, the multi-layer probabilistic knowledge graph 112 includes a first layer, a second layer that is layered on the first layer, and a third layer that is layered on the second layer, with the first layer including or corresponding to a domain ontology knowledge graph, the second layer including or corresponding to a probabilistic ontology graph model, and the third layer including or corresponding to a decision optimization model. For example, the knowledge engine 124 provides the functionality for generating the domain ontology knowledge graph (e.g., the first layer), the probabilistic modelling engine 126 provides the functionality for generating the probabilistic ontology graph model (e.g., the second layer), and the optimization engine 128 provides the functionality for generating the decision optimization layer, as further described herein.

The multi-layer probabilistic knowledge graph 112 integrates multiple types of information related to the ontology 160 and the domain data 162 into a single model that may be queried for information from any or all of the layers simultaneously. A knowledge graph may represent a network where nodes represent concepts and directed edges represent relationships between concepts. Relationship types indicated by at least some knowledge graphs can be broadly classified into two categories: those that specify the underlying hierarchical structure of the data, and those that specify other types of relationships between concepts. A fact in a knowledge graph may be composed of a triple containing a source concept, relationship, and target concept. As a non-limiting example, a fact may be represented by the triple Panda-eats-Bamboo. Knowledge graphs may typically be structured via an expert-curated domain ontology that defines how various types of data relate to each other. The ontology specifies how each relationship type can be used. As an example, an ontology about movies may contain a relationship called “appeared_in,” and the ontology may specify that this relationship must connect a node that is a subclass of actor or actress to a node that is a subclass of movie. In their general form, knowledge graphs do not support reasoning under uncertainty, as each link indicates an absolute truth. To represent uncertainty in a knowledge graph, the multi-layer probabilistic knowledge graph 112 includes the second layer of the probabilistic ontology graph model, which uses the principles of Bayesian statistics. Bayesian networks are Probabilistic Graphical Models (PGMs) that are useful for predicting the likelihood of conditional events. Nodes in a Bayesian network represent Random Variables (RVs), which are mappings between possible outcomes in the data and the data themselves. Directed edges in a Bayesian network represent the presence of conditional dependencies between pairs of RVs. For example, a conditional dependency edge might pass from a parent RV node representing the presence of a disease (D) to a child RV node representing the presence of a symptom of that disease (S). The conditional distribution for this dependency is shown by P(S|D), and can be rendered as a Conditional Probability Table (CPT). In this example, both RVs are Bernoulli-distributed (i.e., the RVs are Booleans). The resulting CDT would have two rows and two columns, with the columns corresponding to D being true and D being false, the rows corresponding to S being true and S being false, and the entries including four probability values corresponding to each of the four possible outcomes and that have a sum of one. In Bayesian statistics, prior distributions of conditional dependencies are combined with the observed data in order to generate a posterior distribution. Priors may represent past knowledge or be set to some “uninformative” default. Each dependency edge of a Bayesian network may have a prior probability P(RV_child|RV_parent), which can be updated accordingly after relevant observed data is taken into account. Each dependency edge may also have a likelihood function, which indicates the mathematical relationship between the parent and the child RVs. It follows that a function for updating the posterior distribution of a RV has as input: a likelihood function, a prior distribution, and observed data. The multi-layer probabilistic knowledge graph 112 layers a Bayesian network over a knowledge graph's domain ontology and data. Domain ontology classes may be mapped to RVs in the Bayesian network, and relationships between classes may be mapped to dependencies in the Bayesian network. As such, each dependency may be associated with a likelihood function and a probability distribution indicating the conditional probability of the target concept given the source concept, based on sampling from the domain data. The third layer contains ontological structures used to represent real-world decisions that are made based on an optimization of a set of the variables included in the second layer (e.g., the Bayesian network). In this manner, the functionality provided by the knowledge engine 124, the probabilistic modelling engine 126, and the optimization engine 128 for creating digital twins enables complex digital twins to be created that provide semantic information, probability distributions, and decision making capabilities for the real-world counterpart.

In an aspect, the computing device 102 may provide an API 129 (which may be one or more APIs in some implementations). The API 129 may enable communication with an application executed by a user (e.g., a user of the computing device 130) and provide functionality for creating digital twins in accordance with the concepts described herein. For example, the API 129 may provide a command prompt or other means that enable the user to upload an ontology (e.g., the ontology 160), domain data (e.g., the domain data 162), or both, as part of a digital twin creation process. The API 129 may additionally provide functionality for leveraging the capabilities and functionality of the data ingestion engine 122, the knowledge engine 124, the probabilistic modelling engine 126, and the optimization engine 128 during the digital twin creation process to generate the digital twin in accordance with the concepts described herein. In an aspect, the API 129 may be provided as part of an application, such as an application stored in the memory 106 and executed by the one or more processors 104 (or similar resources of the computing device 130). In an additional or alternative aspect, the API 129 may be provided by a cloud-based system, such as cloud-based system 142, which may be configured to provide the functionality described herein with reference to the computing device 102 from a cloud-based deployment of computing resources. Additionally, or alternatively, the computing device 102 (or the cloud-based system 142) may be configured to provide one or more graphical user interfaces (GUIs) that include visual elements that enable any or all of the functionality described with reference to the API 129.

As briefly described above, the computing device 102 may be communicatively coupled to one or more computing devices 130 via the one or more networks 140. The computing device 130 may include one or more processors 132, a memory 134, one or more I/O devices (not shown in FIG. 1), and one or more communication interfaces (not shown in FIG. 1). The one or more processors 132 may include one or more microcontrollers, ASICs, FPGAs, CPUs and/or GPUs having one or more processing cores, or other circuitry and logic configured to facilitate the operations of the computing device 130 in accordance with aspects of the present disclosure. The memory 134 may include RAM devices, ROM devices, EPROM, EEPROM, one or more HDDs, one or more SSDs, flash memory devices, NAS devices, or other memory devices configured to store data in a persistent or non-persistent state. Software configured to facilitate operations and functionality of the computing device 130 may be stored in the memory 134 as instructions 136 that, when executed by the one or more processors 132, cause the one or more processors 132 to perform the operations described herein with respect to the computing device 130, as described in more detail below. Additionally, the memory 134 may be configured to store data and information in one or more databases 138. Illustrative aspects of the types of information that may be stored in the one or more databases 138 are described in more detail below.

During operation of the system 100 to generate a digital twin, the computing device 102 may receive an ontology 160 from the computing device 130 and domain data 162 from the data sources 150, or alternatively from the computing device 130. The ontology 160 may provide an abstracted semantic representation of a real world counterpart to the digital twin being designed, where the real world counterpart may be an entity, machine, process, system, or other real world design. The ontology 160 may define the real world counterpart using a representation that defines concepts, properties, and relationships for the real world counterpart using an accepted body of knowledge (e.g., industry accepted terminology and semantics) and may specify object types and their semantic relation to other object types via graph format. Exemplary formats in which the ontology 160 may be received by the computing device 102 include “.owl” and “.ttl,” files.

As a non-limiting example, an ontology for a manufacturer may indicate the manufacturer has production facilities in one or more geographic locations and include, for each production facility, information representing: a floor plan for the production facility, manufacturing infrastructure present at the production facility (e.g., assembly robots, computing infrastructure, equipment, tools, and the like), locations of the manufacturing infrastructure within the production facility, other types of information, or combinations thereof. It is noted that while the exemplary characteristics of the above-described ontology have been described with reference to a manufacturer domain, the ontologies obtained by the computing device 102 may include ontologies representative of other types of domains, such as ontologies associated with processes (e.g., manufacturing processes, computing processes, medical treatment processes, biological processes, chemical processes, etc.), ontologies associated with machinery or equipment (e.g., a vehicle, a computing device or component thereof, circuitry, robots, etc.), ontologies associated with biological systems, and the like. Accordingly, it should be understood that the operations disclosed herein with reference to the computing device 102 may be applied to any industry, process, machine, etc. capable of representation via an ontology. The domain data 162 includes data related to the domain represented by the ontology 160, such as operational data, patient data, sensor data, customer data, transaction data, or other types of data associated with the domain.

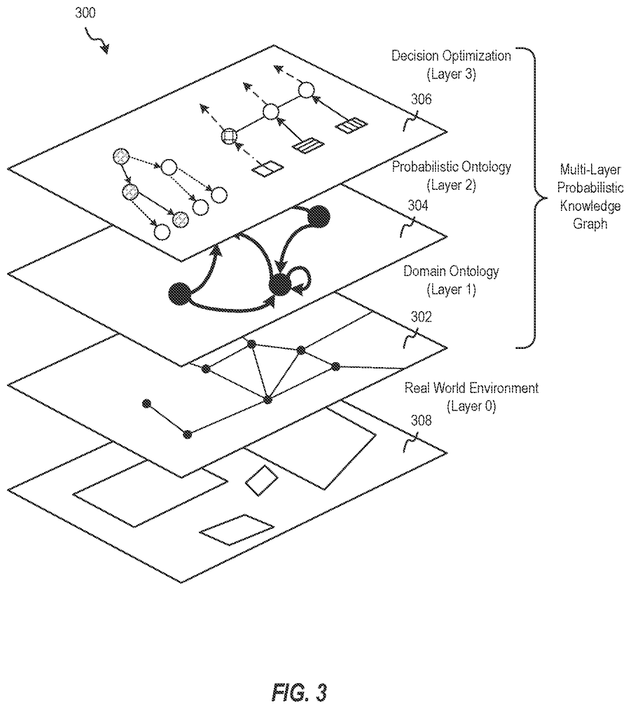

As briefly described above, the computing device 102 provides the functionality for generating digital twins. To illustrate, the data ingestion engine 122 receives and ingests the ontology 160 and the domain data 162, and after ingestion, the ontology 160 and the domain data 162 may be provided to the knowledge engine 124, the probabilistic modelling engine 126, and the optimization engine 128 and used to create a digital twin based on the ontology 160 and the domain data 162. The digital twin may be created as the multi-layered probabilistic knowledge graph 112. As described briefly above, the multi-layered probabilistic knowledge graph 112 may include, as a first layer, a domain ontology knowledge graph created by the knowledge engine 124, and as a second layer that is layered on the first layer, a probabilistic ontology graph model created by the probabilistic modelling engine 126. In some implementations, the multi-layered probabilistic knowledge graph 112 further includes, as a third layer that is layered on top of the second layer, a decision optimization model created by the optimization engine 128. Additional details of the structure of a multi-layered probabilistic knowledge graph are described further herein with reference to FIG. 3.

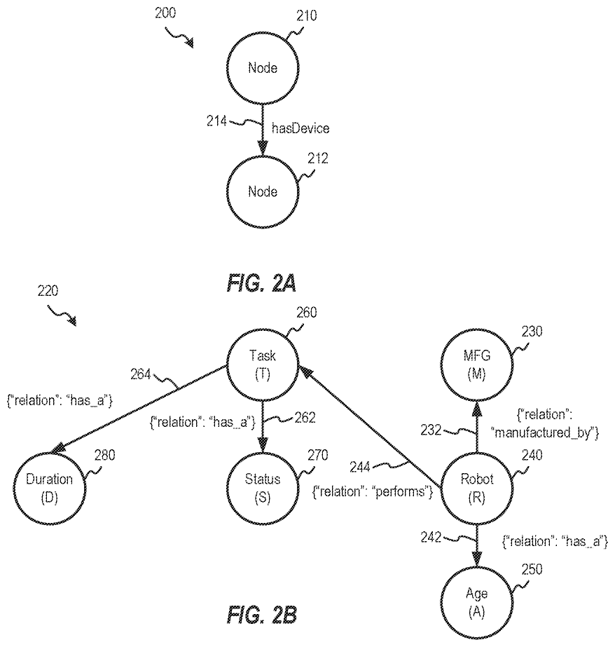

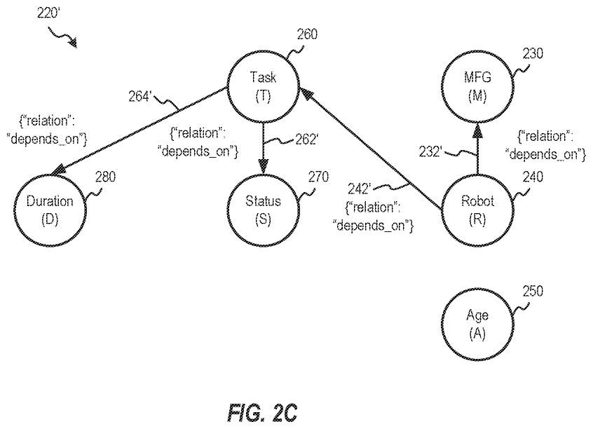

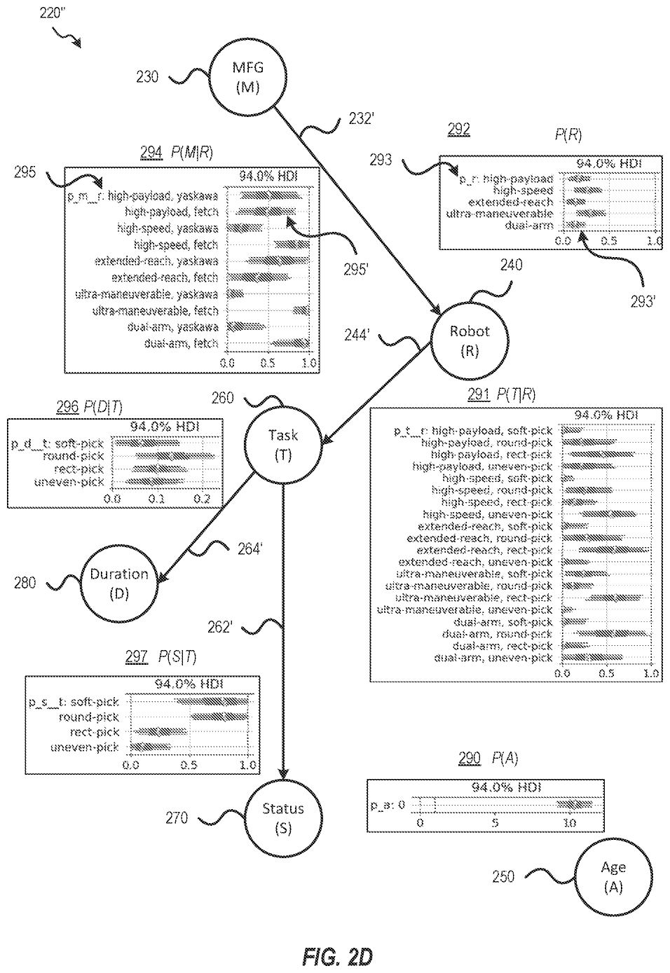

The knowledge engine 124 may create the domain ontology knowledge graph based on the object types, semantic relationships, and other information specified in the ontology 160. As an illustrative example and referring to FIG. 2A, a block diagram illustrating exemplary aspects of a knowledge graph in accordance with aspects of the present disclosure is shown as a knowledge graph 200. The knowledge graph 200 includes nodes 210, 212 connected via an edge 214. The nodes 210, 212 are digital representations of physical assets (e.g., physical locations, devices, machines, processes, etc.) identified in a corresponding ontology and different nodes may be associated with different node types based on properties derived from the ontology. To illustrate using the simplified example shown in FIG. 2A, node 210 represents a first node type—a physical location, such as a warehouse or production facility—and node 212 represents a second node type—an asset, such as robot, present in the physical location corresponding to the node 210. The edges of the knowledge graphs may be determined based on the ontology and may be used to formalize semantic relationships within the knowledge graph. For example, in FIG. 2A the edge 214 indicates a semantic relationship between the nodes 210, 212, namely, that the robot represented by the node 212 is located at the physical location represented by the node 210, as indicated by the label “hasDevice” associated with the edge 214 (e.g., the edge 214 indicates the location corresponding to the node 210 has a device corresponding to the node 212). It is noted that the edges of the knowledge graph may be defined such that they point from one node to another node (e.g., from node 210 to node 212) or from a node to data, and the particular node an edge points to may be determined based on the semantic relationship information included in the ontology (e.g., the ontology 160 of FIG. 1).

In addition to nodes representing assets, other types of nodes may be provided in a knowledge graph, such as nodes representing attributes (e.g., an age of a machine or robot represented in the knowledge graph), processes steps (e.g., tasks performed by a machine or robot represented in the knowledge graph), entities (e.g., a manufacturer of a machine or robot represented in the knowledge graph), or other types of nodes. As described above, these nodes may be connected to other nodes via edges. For example, the knowledge graph 200 could be generated to include a task node (not shown in FIG. 2A) that is connected to the node 212 representing a robot via an edge that points from the node 212 to the task node to indicate that the robot performs the task associated with the task node. Similarly, the knowledge graph 200 could be generated (e.g., by the knowledge engine 124) to include an attribute node (not shown in FIG. 2A) that is connected to the node 212 representing a robot via an edge that points from the node 212 to the attribute node to indicate that the robot has the attribute associated with the attribute node. Likewise, the knowledge graph 200 could be generated to include an entity node (not shown in FIG. 2A) that is connected to the node 212 representing a robot via an edge that points from the entity node to the node 212 to indicate that the robot was produced by the entity associated with the entity node.

The knowledge graph 200 may also incorporate other types of data, such as historical data and metadata. To illustrate, node 212 is described in the example above as representing a robot that performs a task. Sensors or other devices may monitor performance of the task by the robot and generate data associated with performance of the task, such as the number of times the task was performed, whether the task was performed successfully or not, a duration of time required for the robot to complete the task, or other types of data. The dataset generated during the monitoring may be stored in the knowledge graph 200. Additionally, metadata may also be stored in the knowledge graph 200, for example, the physical location of where a certain data point is stored, and more specifically, which database on which server and what the IP address of the server is. Additional metadata can also include access privileges for certain users to this data which can be for a subset of the knowledge graph 200.

Referring back to FIG. 1, the domain ontology knowledge graph created by the knowledge engine 124 provides a qualitative representation of the ontology 160. For example, the domain ontology knowledge graph provides a representation of the real world assets represented by the ontology (e.g., the nodes of the domain ontology knowledge graph) and semantic relationships between the assets (e.g., the edges of the domain ontology knowledge graph). At this point, the domain ontology knowledge graph produced by the knowledge engine 124 enables explicit knowledge to be obtained from the domain ontology knowledge graph using logical inferences. This represents a simplified example that may be leveraged by the knowledge engine 124. In some implementations, the domain ontology knowledge graph created by the knowledge engine 124 may be customized or tuned in a manner to enable generation of digital twins that support specific more than one instance of a specific real world counterpart and that are not generated in a static manner.

As a non-limiting example and with reference to FIG. 2B, a block diagram of a knowledge graph in accordance with aspects of the present disclosure is shown as a knowledge graph 220. As explained above, the knowledge graph 220 may be generated by the knowledge engine 124 based on an ontology, such as the ontology 160 of FIG. 1. As shown in FIG. 2B, the knowledge graph 220 includes nodes 230, 240, 250, 260, 270, 280, where node 230 represents a manufacturer (M), node 240 represents a robot (R), node 250 represents an age (A) (i.e., an attribute), node 260 represents a task (T), node 270 represents a status (S), and node 280 represents a duration (D). The knowledge graph 220 also includes a series of edges 232, 242, 244, 262, 264 that connect different ones of the nodes 230, 240, 250, 260, 270, 280 to indicate semantic relationships among the nodes 230, 240, 250, 260, 270, 280. For example, edge 232 points from the node 240 (i.e., the robot) to the node 230 (i.e., the manufacturer) to indicate the relationship between nodes 230, 240 is the robot was manufactured by the manufacturer. The edge 242 points from node 240 (i.e., the robot) to the node 250 (i.e., the age attribute) to indicate the relationship between nodes 240, 250 is that the robot has an age. The edge 244 points from node 240 (i.e., the robot) to the node 260 (i.e., the task) to indicate the relationship between nodes 240, 250 is that the robot performs the task. The edge 262 points from node 260 (i.e., the task) to the node 270 (i.e., the status) to indicate the relationship between nodes 260, 270 is that the task has a status. Similarly, the edge 264 points from node 260 (i.e., the task) to the node 280 (i.e., the duration) to indicate the relationship between nodes 260, 280 is that the task has a duration.

Referring back to FIG. 1, as part of the process for creating a knowledge graph (e.g., the knowledge graph 220 of FIG. 2B), the functionality of the knowledge engine 124 may be leveraged to incorporate data from one or more data sources 150. For example, the data sources 150 may include sensors or devices 152 (hereinafter “sensors 152”), systems 154, or other sources of data (e.g., the database(s) 138, etc.). The sensors 152 may include Internet of things (IOT) devices, temperature sensors, motion sensors, weight sensors, pressure sensors, network traffic sensors, reading devices (e.g., magnetic card reader devices, radio frequency identified (RFID) devices, chip card readers, or other types of devices configured to read information from a device scanned in proximity to the reading device(s)), fuel sensors, accelerometers, gyroscopes, or other types of sensors configured to detect information of interest with respect to a real world counterpart. In addition, the sensors 152 may include other types of devices that may provide information of interest for use in analysis and understanding using a digital twin, such as controllers, navigation systems, communication devices, or other types of devices that may collect or generate information related to operations or functioning of the real world counterpart of a digital twin. Furthermore, the systems 154 may include enterprise resource planning (ERP) systems or other types of systems that may contain information related to the real world counterpart corresponding to a digital twin being created using the system 100.

As can be appreciated from the foregoing, information pertaining to a real world counterpart of a digital twin can include many different data sources 150 and types of data. Rather than attempting to design a digital twin generation platform that is specifically configured for specific data types and data sources, the present disclosure provides a data ingestion engine 122 that provides functionality for obtaining or receiving information from a variety of data sources and storing the data in the one or more database 110. Once stored, the knowledge engine 124 may be used to create or extend the domain ontology knowledge graph (e.g., the knowledge graph 220 of FIG. 2B) to incorporate the data obtained by the data ingestion engine 122. For example, data obtained by the data ingestion engine 122 in connection with the knowledge graph 220 of FIG. 2B may include information associated with one or more types of robots corresponding to node 240 (e.g., high-speed robots, ultra-maneuverable robots, high-payload robots, extended-reach robots, etc.), the manufacturer of each type of robot, the age of the robots, tasks that can be performed by each different robot, information regarding a duration for instances of each robot performing a corresponding task, information regarding a status of each task (e.g., completed/not completed, success/fail, etc.), or other types of information.

It is to be understood that the exemplary types of information described above in connection with the information represented by the knowledge graph 220 of FIG. 2B that may be collected by the data ingestion engine 122 have been provided for purposes of illustration, rather than by way of limitation and that other types of data may be ingested into the computing device 102 by the data ingestion engine 122 in connection with the creation of digital twins involving other types of real world counterparts. For example, a manufacturing facility may be represented as a digital twin and the data ingestion engine 122 may obtain information associated with various aspects of the manufacturing process, such as the order in which the manufacturing process is performed, the materials and/or machinery or equipment involved in each stage of the manufacturing process, the sources of the materials, the storage locations of the materials, operations performed by the machinery or equipment during the manufacturing process, packaging of the products once produced, or any other types of steps, processes, or features that may be needed to model the manufacturing process as a digital twin. As another example, a healthcare services provider may be represented as a digital twin and the data ingestion engine 122 may obtain information associated with various aspects of the healthcare services process, such as the patients treated by the healthcare services provider, the operations or treatments performed at various buildings or centers, the medical supplies used in the treatment or diagnosis of medical conditions by healthcare service personnel, medical records generated during the course of healthcare services, or any other types of steps, processes, or features that may be useful to model the healthcare services as a digital twin.

As another example, the computing device 102 may also enable digital twins (e.g., each layer of, or the entirety of, the multi-layer graph structure) to be created in a system of systems-type manner whereby multiple digital twins are created and combined into a digital twin of digital twins, such as a digital twin of a process for producing the materials, a materials acquisition process, a manufacturing process, shipping or logistics process and/or system, and other aspects of the life cycle from producing materials, to manufacturing products, to delivering the products to end users or consumers. Such system of systems-type digital twins may be used to represent complex workflows, processes, equipment, and the like, thereby enabling the creation of digital twins for entire ecosystems, which is a capability that is currently not available using existing digital twin platforms and tools. During creation of such complex digital twins as those described above, many different types of data may be obtained for incorporation into knowledge graphs generated by the knowledge engine 124.

In some aspects, the functionality of the data ingestion engine 122 may be provided via an API 129 that enables a user to specify the data sources 150 of interest (i.e., which data sources of the data sources 150 from which to obtain data for a digital twin), the types of data to be obtained, and a frequency at which the data should be obtained. For example, the knowledge graph 220 of FIG. 2B relates to digital twin of a robot that performs tasks. In the context of the digital twin (e.g., the knowledge graph), the robot may be any type of robot and the tasks performed by the robot may vary according to a particular robot of interest. In this manner the digital twin may be independent of any specific real world counterpart represented by the knowledge graph (i.e., the first layer). To facilitate use of the digital twin for analysis and understanding of the real world counterpart, data associated with a particular real world counterpart or multiple real world counterparts (e.g., one or more robots) may be incorporated into the knowledge graph 220.

By incorporating collections of data from the data sources 150 into the knowledge graph (i.e., the first layer of the multi-layer probabilistic knowledge graph 112), the knowledge engine 124 enables additional types of information to be derived from this layer of the digital twin, such as information quantifying relationships between different pairs of nodes. Additionally or alternatively, the information of the domain ontology knowledge graph may be used by the probabilistic modelling engine 126 to generate a probabilistic graph model as the second layer of the multi-layer probabilistic knowledge graph 112, such as a probabilistic ontology graph model. For example and referring to FIG. 2C, a block diagram illustrating a probabilistic graph model in accordance with aspects of the present disclosure is shown as a probabilistic graph model 220′. In some implementations, the probabilistic graph model 220′ may include or correspond to the second layer of the multi-layer probabilistic knowledge graph 112 generated by the probabilistic modelling engine 126 of FIG. 1. It is noted that, unlike the knowledge graph 220 of FIG. 2B, the edges 232′, 242′, 262′, and 264′ do not include an edge between node 240 and node 250. This is because edges of the knowledge graph 220 of FIG. 2B represent semantic relationships while the edges of the probabilistic graph model 220′ represent statistical dependencies. Since the age (A) associated with the node 250 is not statistically dependent on the robot (R) represented by the node 240, the probabilistic graph model 220′ does not include an edge between nodes 240, 250. Additionally, the edges 232, 242, 262, 264 indicate non-dependency-type relationships between the different pairs of nodes connected by these edges (e.g., “manufactured_by”, “has_a”, “performs”) while the edges 232′, 242′, 262′, 264′ indicate statistical dependencies (e.g., “{‘relation’: ‘depends_on’}”), such as indicating that the variable (R) depends on the variable (M) (e.g., robots may be produced by different manufacturers), the task (7) associated with node 260 depends on the robot (R) associated with the node 240 (e.g., performance of a particular task depends on the robot since different robots can perform different tasks), and so on.

As a Bayesian network, the probabilistic graph model 220′ may enable probabilistic querying of the random variables, which may be used to inferentially extract additional information that is not able to be derived from the knowledge graph alone (e.g., because the knowledge graph is limited to logical inferences). For example, the joint distribution of the probabilistic graph model may enable queries to be used to determine: whether one subset of the variables is independent of another; whether one subset of variables is conditionally independent of another subset given a third subset; and calculating conditional probabilities. To generate the probabilistic graph model 220′, the probabilistic modelling engine 126 may treat each node of the knowledge graph 220 as a random variable (e.g., variables {A, R, M, T, S, D), . . . } in FIGS. 2B, 2C) representing a probability distribution for each variable. The probability distributions for each variable describe the possible values that a corresponding random variable can take and a likelihood (or probability) of the random variable taking each possible value. To obtain the probability distributions, the probabilistic modelling engine 126 may utilize Bayesian learning to derive a joint distribution for the domain ontology knowledge graph based on the random variables and available data (e.g., data obtained by the data ingestion engine 122 from the data sources 150 and incorporated into the domain ontology knowledge graph by the knowledge engine 124). Exemplary aspects of converting a knowledge graph into a probabilistic graph model are described in commonly owned U.S. patent application Ser. No. 17/681,699, filed Feb. 25, 2022, and entitled “SYSTEM FOR PROBABILISTIC REASONING AND DECISION MAKING ON DIGITAL TWINS,” the contents of which are incorporated herein by reference.

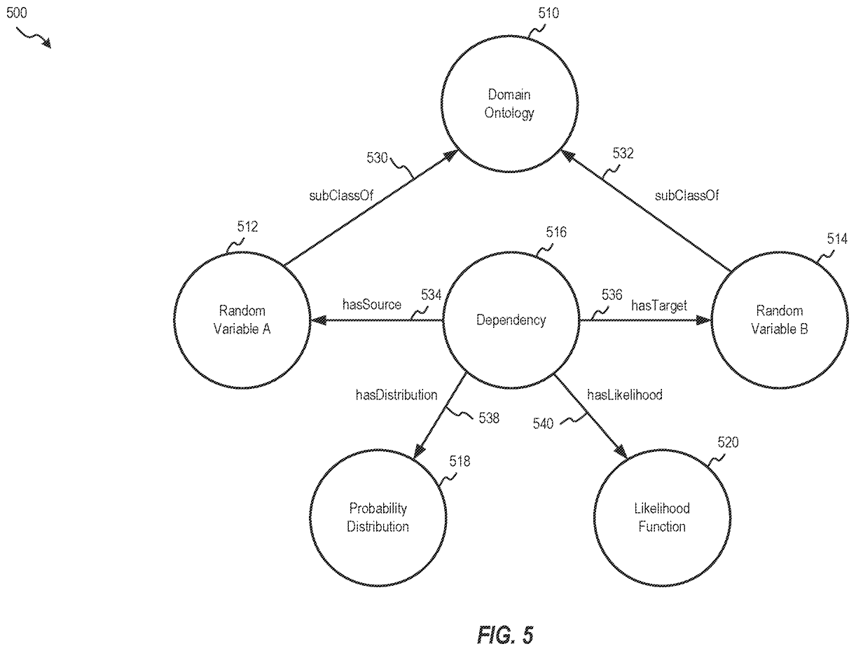

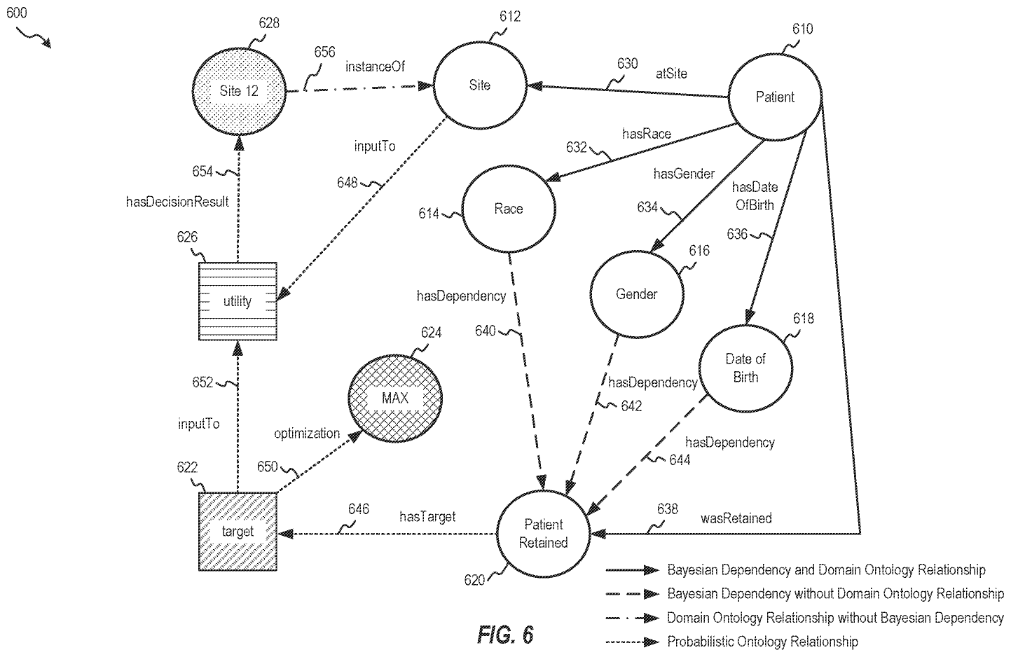

Instead of requiring a user (e.g., a user of the computing device 130 of FIG. 1) to specify a type for each distribution associated with the random variables, or a domain expert to provide a curated list of distribution types, the probabilistic modelling engine 126 automatically infers the distributions and likelihoods of each of the random variables from the first layer (e.g., the domain ontology knowledge graph), thereby constructing a probabilistic graph model without requiring the user to be an expert in probability theory or to provide significant user input during initialization of the digital twin. For example, the probabilistic ontology graph model (e.g., the second layer of the multi-layer probabilistic knowledge graph 112) may be automatically generated without user input defining random variables represented by the probabilistic ontology graph model or distributions between the random variables. Instead, the distribution types are determined automatically by the computing device 102 and associated with the random variables as part of an automatic process by the probabilistic modelling engine 126 to generate the probabilistic ontology graph model (e.g., the second layer of the multi-layer probabilistic graph model). Additionally or alternatively, the computing device 102 may receive a user input that indicates one or more additional random variables, one or more additional dependencies between random variables, or both, and the probabilistic modelling engine 126 may add the additional random variables, the additional dependencies, or both, to those that are automatically generated to create or update the probabilistic ontology graph model. In some implementations, the random variables of the probabilistic ontology graph model are mapped to domain ontology classes of the domain ontology knowledge graph and relationships between classes of the domain ontology knowledge graph are mapped to dependencies between the random variables. The edges may correspond to a likelihood function (e.g., a likelihood of the dependency) and a probability distribution indicating a conditional probability of a target concept (e.g., a node pointed toward by the edge) given a source concept (e.g., a node pointed away from by the edge). The probabilistic modelling engine 126 may automatically determine the likelihood functions and the probability distributions based on sampling the domain data 162, as further described herein. As a non-limiting example of associating distribution types to random variables, in probability theory Poisson distributions express the probability of a given number of events occurring in a fixed interval of time or space independent of the time since the last event. Since the age of a robot advances at a constant rate independent of the time a last change in age occurred, the probabilistic modelling engine 126 may associate the Poisson distribution type with the age variable (A). As another example, categorical distributions describe the possible results of a random variable that can take on one of K possible categories. The probabilistic modelling engine 126 may associate the categorical distribution type to the variables M, R, T since the probabilistic graph model may represent an environment (e.g., the environment defined in the ontology from which the knowledge graph was generated) where many different types of robots are present, each type of robot manufactured by a particular manufacturer and capable of performing a defined set of tasks, all of which define a set of K possible categories for M, R, T, respectively (i.e., a set of K manufacturer categories, a set of K robot categories, and a set of K task categories). Similarly, a Bernoulli distribution represents the discrete probability of a random variable which takes on the value of 1 with probability p and the value of 0 with probability q=1−p (i.e., success or failure). Since the status variable (S) indicates whether the task was performed successfully or failed, the probabilistic modelling engine 126 may associate the Bernoulli distribution type with the status variable (S). The probabilistic modelling engine 126 may assign the exponential distribution type to the duration parameter (D)), which represents the amount of time taken to perform a task, because exponential distributions represent the probability distribution of the time between events. It is noted that the exemplary variables, probability distributions, and distribution types described above have been provided for purposes of illustration, rather than by way of limitation and that probabilistic graph models generated in accordance with the present disclosure may utilize other distributions, distribution types, and variables depending on the particular real world counterparts being represented by the probabilistic graph model generated in accordance with the concepts disclosed herein. Additional details about automatically determining distribution types and inferring distributions and likelihoods of random variables is further described herein with reference to FIG. 5.

Another example of a probabilistic graph model 220″ generated in accordance with the present disclosure is shown in FIG. 2D, which is a block diagram illustrating a layer of a multi-layer probabilistic knowledge graph of a digital twin that provides probabilistic reasoning capabilities in accordance with the present disclosure. In some implementations, the probabilistic graph model 220″ may include or correspond to the second layer of the multi-layer probabilistic knowledge graph 112 generated by the probabilistic modelling engine 126 of FIG. 1. For example, the probabilistic graph model shown in FIG. 2D represents a probabilistic graph model 220″ obtained by solving the joint distribution of the knowledge graph 220 automatically using the functionality provided by the probabilistic modelling engine 126 of FIG. 1. To illustrate, the joint distribution may be represented as:

$$P ( A , R , M , T , D , S ) = P ( A ) P ( R ) P ( M \vert R ) P ( T \vert R ) P ( D \vert T ) P ( S \vert T ) \qquad ( Equation 1 )$$

where P(A) is the probability distribution for the variable A, P(R) is the probability distribution for the variable R, P(M|R) is the probability distribution for the variable M|R representing the statistical dependency between manufacturers (M) and robots (R), P(T|R) representing the statistical dependency between tasks (7) and robots (R), P(D|T) representing the statistical dependency between duration (D) and tasks (T), and P(S|T) representing the statistical dependency between tasks (T) and status (S). Using the Bayesian learning processes mentioned above, approximations of any unknown parameters may be learned through simulation using a generative program or through other automatic learning processes.

As a non-limiting example, the generative program may be generated via functionality of the probabilistic modelling engine 126 and may include a series of deterministic and probabilistic statements, such as:
P(A)˜Gamma (1, 1)
age˜Poisson (p(A))
p(R)˜Dirichlet(1)
robot˜Categorical (p(R))
p(M|R)˜Dirichlet (0.5)
manufacturer˜Categorical (p(M|R=robot))
p(TR)˜Dirichlet (0.25)
task˜Categorical (p(T|R=robot))
p(D|T)˜Gamma (1,1)
duration˜Exponential (p(D|T=task))
p(S|T)˜Beta (1,1)
status˜Bernoulli (p(S|T=task))
   In the exemplary statements above, the deterministic statements are those statements including an assignment (e.g., “=”) and the remaining statements represent probabilistic statements. The generative program provides a model that may be used to estimate or approximate the unknown parameters. For example, the probabilistic modelling engine 126 may configure the generative program with a set of guessed parameters and run a simulation process to produce a set of simulation data. The set of simulation data may then be compared to observed data to evaluate how closely the simulation data obtained using the guessed parameters matches or fits actual or real world data. This process may be performed iteratively until the simulated data matches the actual data to within a threshold tolerance (e.g., 90%, 95%, etc.). It is noted that as the set of data grows larger, the ability to estimate or guess the parameters may improve. Thus, the above-described learning process may be periodically or continuously performed and the accuracy of the estimations of the unknown parameters may improve as the set of data grows larger.

Once the unknown parameters are obtained, the probability distributions P(A), P(R), P(M|R), P(T|R), P(D|T), P(S|T) having the approximated parameters may be embedded within the probabilistic graph model 220″. As shown in FIG. 2D, embedding the probability distributions into the probabilistic graph model 220″ may associate the probability distributions with an edge or a node. In particular, the probability distributions are associated with edges when the probability distributions correspond to statistical dependencies between a pair of nodes and probability distributions associated with independent random variables may be associated with nodes. For example, in FIG. 2D the probability distribution P(A) 290 is associated with the node 250 and the probability distribution P(R) 292 is associated with the node 240, while the probability distributions P(M|R) 294, P(T|R) 291, P(D|T) 296, P(S|T) 297 are associated with the edges 232′, 244′, 264′, and 262′, respectively.

Once the probability distributions having the guessed or estimated parameters are added, the probabilistic graph model 220″ is capable of providing, via query, information that would otherwise not be available using a knowledge graph, such as the knowledge graph 220 of FIG. 2B. For example, the probabilistic graph model 220″ represents a model of an environment where different robots performs tasks. The probability distribution P(R) 292 includes all possible values 293 of the variable R (e.g., the variable R may take on values of “high-payload”, “high-speed”, “extended-reach”, “ultra-maneuverable”, and “dual-arm”) and each possible value may have an associated probability 293′. Similarly, the probability distribution P(M|R) 294 includes all possible values 295 for the statistical dependency (represented by edge 232′) for the variables M and R (e.g., the possible combinations for the variables M, R may include “high-payload, yaskawa”, “high-payload, fetch”, “high-speed, yaskawa”, “high-speed, fetch”, “extended-reach, yaskawa”, “extended-reach, fetch”, “ultra-maneuverable, yaskawa”, “ultra-maneuverable, fetch”, “dual-arm, yaskawa”, and “dual-arm, fetch”) and each possible value may have an associated probability 295′. The probability distribution P(A) 290 may follow a structure similar to the probability distribution P(R) 292, but provides all possible values and their corresponding probabilities for the random variable A; the probability distributions P(T|R) 291, P(D|T) 296, P(S|T) 297 may follow a structure similar to the probability distribution P(M|R) 294, but provide all possible values and their corresponding probabilities for the statistical dependencies associated with their random variable pairs (e.g., T|R, D|T, S|T, respectively).

The probability distributions obtained by extending knowledge graphs to probabilistic graph models facilitate analysis and understanding with respect to the real world counterparts represented by the digital twins that goes beyond what is provided by knowledge graphs alone, such as probabilistic reasoning or analysis. For example, a query P(M|S=success) may be defined and used to analyze the question: What is the best performing manufacturer? Executing the query against the probabilistic graph model 220″ using the joint distribution P(A, R, M, T, S, D)) returns a distribution that indicates which manufacturer has a higher probability of successfully completing a task as compared to other manufacturers. As another example, a query P(D|R=dual alarm, T=softpick) may be used to analyze the question: What is the expected duration of a soft object pick performed by a dual arm robot? Executing the query against the probabilistic graph model 220″ using the joint distribution P(A, R, M, T, S, D)) returns a distribution that indicates the expected duration (e.g., in units of time) probabilities for performing the task and may enable insights into what the range of probabilities is for the duration (e.g., what duration has the highest probability, what duration has the lowest probability, and the probabilities of intermediate durations). It is noted that this query could be modified to evaluate the expected duration of performing other types of tasks using a dual-arm robot by changing the task variable T and/or may be modified to evaluate the expected duration of performing the soft object pick using another type of robot (i.e., other than a dual-arm robot) by changing the variable D|R. As yet another example, a query P(S|R=high-speed, T=round-pick) may be used to analyze the question: What is the likelihood of task failure when using a high-speed robot to pick round objects? Executing the query against the probabilistic graph model 220″ using the joint distribution P(A, R, M, T, S, D)) returns a distribution that indicates whether the likelihood of success is greater than the likelihood of failure. It is noted that the exemplary queries described above have been provided for purposes of illustrating the types of insights that may be obtained from probabilistic graph models. However, it should be understood that other types of queries and insights may be obtained by applying similar querying techniques to digital twins formed from probabilistic graph models representing other types of real world counterparts. Further, it is noted that the exemplary queries described above are provided for illustration, and that in implementations further described herein, queries may be executed against the entirety of the multi-layer probabilistic information graph (e.g., against multiple layers concurrently) instead of against layers individually, in accordance with aspects of the present disclosure.

Referring back to FIG. 1, after generation of the probabilistic ontology domain model by the probabilistic modelling engine 126, the optimization engine 128 may generate an optimization model as the third layer of the multi-layer probabilistic knowledge graph 112, such as a decision optimization model. The decision optimization model represents decisions made based on an optimization of a set of variables (e.g., random variables) from the second layer of the multi-layer probabilistic knowledge graph 112 (e.g., the probabilistic ontology domain model). The decisions optimization model may include one or more decision nodes that represent decisions based on corresponding probability distribution(s). To illustrate, a decision node may correspond to: a user-provided target that represents an ideal state of a system represented by the multi-layer probabilistic knowledge graph 112; a set of dependent variables, independent variables, or a combination thereof, over which to predict a decision; and an outcome that includes an entity in the multi-layer probabilistic knowledge graph 112 or a numeric value. An example of a decision optimization model and additional details are further described herein with reference to FIG. 6.

The multi-layer probabilistic knowledge graph 112 generated by the knowledge engine 124, the probabilistic modelling engine 126, and the optimization engine 128 enable creation of digital twins that provide improved capability and insights that facilitate improved analysis and understanding to be obtained with respect to the real world counterparts represented by the digital twins through enhanced querying. To illustrate, instead of querying a model represented by each layer of the multi-layer probabilistic knowledge graph 112 individually and having to somehow aggregate the results to provide the desired insights, a query 114 may be performed on the multi-layer probabilistic knowledge graph 112 in its entirety (e.g., as a whole) to return semantic information, probability distributions or analysis, decision making and optimization information, or any combination thereof, through a single query 114 that returns information faster and more efficiently through concurrent access of the multiple layers than separately performing individual layer-specific queries and kluging the results together. For example, a query may be defined and used to analyze the question: For the tasks having durations that most closely match a provided target distribution, what are manufacturers of robots with the most common statuses? Executing the query against the multi-level probabilistic knowledge graph representing the digital twin using returns information that indicates which manufacturers of robots that perform tasks having the most similar duration to the target distribution are associated with the most common statuses resulting from performance of all tasks by all robots. Additional examples of queries are described further herein with reference to FIG. 6. The query 114 may be generated via the API 129 that provides query building functionality to enable the computing device 102 to receive user input indicating one or more query parameters and to generate the query 114 based on the user input. Additionally or alternatively, the computing device 102 may generate and display a GUI that facilitates the query building, that displays one or more query results, or both. In some implementations, the computing device 102 generates a control signal based on a query result and transmits the control signal to the real world counterpart of the digital twin to cause performance of one or more actions based on the query results. As a non-limiting example, the computing device 102 may transmit a control signal that causes a robot to perform one of the operations described with reference to FIGS. 2A-D based on a query result that indicates a probability distribution of the duration of performance of the operation.

In a particular implementation, a system that supports creating digital twins is disclosed. The system includes a memory (e.g., 106) and one or more processors (e.g., 104) communicatively coupled to the memory. The one or more processors are configured to obtain a dataset that includes an ontology (e.g., 160) and domain data (e.g., 162) corresponding to a domain associated with the ontology. The one or more processors are also configured to generate a multi-layer probabilistic knowledge graph (e.g., 112) based on the ontology and the domain data. The multi-layer probabilistic knowledge graph represents a digital twin of a real world counterpart (e.g., 154). To generate the multi-layer probabilistic knowledge graph the one or more processors are configured to construct a first layer of the multi-layer probabilistic knowledge graph based on the ontology and the domain data. The first layer includes a domain ontology knowledge graph that incorporates at least a portion of the domain data. To generate the multi-layer probabilistic knowledge graph the one or more processors are also configured to automatically construct a second layer of the multi-layer probabilistic knowledge graph based on the first layer. The second layer includes a probabilistic ontology graph model that includes probability distributions for one or more variables. The one or more processors are further configured to run a query (e.g., 114) against the first layer and the second layer to obtain a query result. The query result includes one or more portions of the domain data, one or more of the probability distributions, or a combination thereof.

As described above, the system 100 the functionality for generation of digital twins in an ontology-driven manner with less user input and that support improved querying capabilities as compared to other digital twins or individual information graph and probabilistic graph model-based technologies. For example, the system 100 enables a user to provide the ontology 160 to be used to generate a first layer (e.g., a domain ontology knowledge graph) of the multi-layer probabilistic knowledge graph 112 as part of a digital twin creation process. The system 100 may automatically convert the domain ontology knowledge graph to a second layer (e.g., a probabilistic ontology graph model) of the multi-layer probabilistic knowledge graph 112 by mapping ontology domains to random variables and sampling the domain data 162. This technique allows for quick conversion of domain knowledge into conditional probability distributions, which can be processed faster than the domain data itself. By storing the distributions as a layer on top of and integrated with the domain ontology knowledge graph, both layers can be accessed (e.g., traversed) simultaneously, enabling more flexible types of queries with better performance as compared to individually querying single models and aggregating the results. The functionality of system 100 also provides the ontological structures necessary to support decision optimization by layering a third layer, the decision optimization model, on the probabilistic domain graph model (e.g., the second layer). As such, the system 100 provides functionality for generating digital twins that automates the creation and integration of probabilistic graph models from user-supplied domain ontologies, such that the user does not have to manually create any graph structures or do any ontology modeling to obtain the probabilistic graph layer. Additionally, the system 100 creates the digital twins by mapping ontology classes to random variable nodes and ontology properties to Bayesian dependencies, as opposed to defining ontology properties themselves as random variables. This new technique for constructing a probabilistic ontology graph model preserves the original structure of the ontology in the Bayesian network, rather than requiring additional abstractions away from the ontology. Another benefit is that the system 100, in generating the digital twins as described above, rather than explicitly representing conditional probability tables (CPTs), which limits the ontology to processing discrete variables, instead models the relationship between random variables using likelihood functions. As such, the system 100 provides for the creation and use of digital twins to model real world counterparts in a manner that enables extraction of multiple types of information, including semantic information, probability distributions, decision optimization information, and the like, using a faster and more effective querying process.

It is noted that the system 100 (e.g., the data ingestion engine 122, the knowledge engine 124, the probabilistic modelling engine 126, and the optimization engine 128 of the computing device 102 of FIG. 1) may leverage various technologies to support the functionality described above with reference to FIGS. 1 and 2A-D and below with reference to FIGS. 3-7. For example, the computing device 102 may utilize APIs to obtain information utilized to generate digital twins (e.g., ontologies, data from the one or more data sources 150 of FIG. 1, etc.) and to provide information derived from digital twins to users. Furthermore, while the functionality described herein has been primarily with reference to generating digital twins using the computing device 102 or a cloud-based implementation of the computing device 102 (e.g., the cloud-based system 142 of FIG. 1), it is to be appreciated that the functionality for generating digital twins may also be provided local to a user device (e.g., the computing device 130 of FIG. 1). In such an implementation the user device may execute an application for generating digital twins in accordance with aspects of the present disclosure, and the application may be stored as instructions (e.g., the instructions 136) in a memory (e.g., the memory 134) of the user device.

It should also be understood that the present disclosure provides a generalized platform that includes a suite of tools that facilitate rapid creation of digital twins for specific use cases and that may be readily reused or modified for additional use cases, thereby providing more flexibility for modelling real-world counterparts using digital twins and decoupling the digital twin platform and tools from the use cases to which the platform and tools could be applied (e.g., unlike traditional digital twin platforms and tools, the disclosed systems and techniques for producing digital twins are not restricted to particular real-world counterparts, use cases, or analysis). The functionality of the system 100 also provides the advantage of generating digital twins that utilize a single data representation (e.g., data and artificial intelligence (AI)) in which the multiple types of models, such as a data model (e.g., the domain ontology knowledge graph of the first layer), the statistical (AI/ML) model of the data (e.g., the probabilistic ontology graph model of the second layer), and the optimization model (e.g., the decision optimization model of the third layer) are tightly coupled. As such, there is no need to move the data out of the platform to run analytics. Also, since the various models are tightly integrated with the data, the data may be expressed both deterministically and probabilistically, which speeds up computation while also reducing the computational resources required to run the analytics. Similar reductions in resources and improvements in computation time may be experienced due to tightly coupling the decision optimization layer with the probability distributions and likelihood functions of the lower second layer.

Referring to FIG. 3, a diagram of an example of a multi-layer probabilistic knowledge graph according to one or more aspects of the present disclosure is shown as a multi-layer probabilistic knowledge graph 300. The multi-layer probabilistic knowledge graph 300 includes multiple layers that each include a model or other graph-based representation derived from a user-provided ontology, sampled domain data, and for some layers the layer(s) below in the multi-layer probabilistic knowledge graph 300. In some implementations, the multi-layer probabilistic knowledge graph 300 may include or correspond to the multi-layer probabilistic knowledge graph 112 of FIG. 1. The multi-layer probabilistic knowledge graph 300 may generated during creation of a digital twin of a real-world counterpart, such as a system, a device, a process, or the like, as described above.

In the example illustrated in FIG. 3, the multi-layer probabilistic knowledge graph 300 includes three layers: a first layer 302 (“Layer 1”), a second layer 304 (“Layer 2”) that is layered above (e.g., on) the first layer 302, and a third layer 306 (“Layer 3”) that is layered above (e.g., on) the second layer 304. The first layer 302 represents a domain ontology and may include a domain ontology knowledge graph, the second layer 304 represents a probabilistic ontology and may include a probabilistic ontology graph model, and the third layer 306 represents a decision optimization (e.g., configuration or improvement) and may include a decision optimization model. As can be appreciated from FIG. 3, the domain ontology and data (e.g., the first layer 302), the probabilistic ontology (e.g., the second layer 304), and the decision optimization (e.g., the third layer 306) are integrated within the single multi-layer probabilistic knowledge graph 300.

The multi-layer probabilistic knowledge graph 300 may be used as the basis of a digital twin that corresponds to a real world counterpart. This real world counterpart may be modelled as or correspond to a base layer 308 (“Layer 0”) that represents a real world environment of the counterpart for which the digital twin is created, such as a manufacturing plant or medical records ecosystem, a computer system, a process, or the like. To further illustrate, the base layer 308 may represent a real world environment about which decisions are desired to be made, thereby motivating the creation of a digital twin to provide insight and analysis into the decisions. As non-limiting examples, the real world environment of the base layer 308 may include a hospital system, a warehouse floor, a public transportation network, or any other complex system, device, or process that can be modeled via an ontology. At a high level, such an environment will have multiple types of objects and multiple ways that these objects interact with each other. The domain ontology of the first layer 302 may include an expert-curated model that represents the real world environment represented by the base layer 308, as well as include any collected raw data about the real world environment (e.g., domain data). Stated another way, the first layer 302 may contain both the domain ontology and the data about the real world environment. To illustrate, the domain ontology may specify the types of objects that exist in the real world environment and the ways in which the objects interact with each other. The data (e.g., the domain data) may capture actual observations about the objects, the interactions between the objects, or both.

The probabilistic ontology of the second layer 304 may include a Bayesian network composed of random variables, some or all of which are connected by dependency links. Each link may include or correspond to summaries of respective data in the form of conditional probabilistic distributions. To illustrate, the second layer 304 layer may be specified by a probabilistic ontology that defines the classes and relationships necessary to realize probabilistic elements and enables Bayesian inference over a domain ontology. This probabilistic ontology may be designed to support automatic deployment of the second layer 304 over an arbitrary domain ontology. Because of the design of the probabilistic ontology of the second layer 304, no probabilistic elements are required to be manually modeled by a user. For example, the second layer 304 may be automatically generated without requiring user input indicating variable types, initial distributions, or the like. The second layer 304 may include Bayesian probabilistic elements such as random variables, probability distributions, and the conditional dependencies that form a Bayesian network (e.g., a probabilistic graph model). These elements may be automatically generated from the domain ontology of the first layer 302, instead of based on user input. For example, each domain ontology class in the first layer 302 may be mapped to a random variable in the second layer 304, and the structure of the Bayesian network (e.g., the probabilistic ontology) may be approximated based on domain ontology properties determined (e.g., extracted or derived) from the first layer 302. The decision optimization of the third layer 306 may include ontological structures that represent real world decisions that are made based on an optimization of a set of variables from the probabilistic ontology of the second layer 304. To illustrate, the third layer 306 may use the semantic structures specified in the probabilistic ontology of the second layer 304 to store the decisions made by the optimization of a set of random variables against a desired outcome. In some implementations, pre-computed probability distributions may provide decision support in generating the third layer 306 to increase computation speed and reduce computational resource use in creating the third layer 306. In some other implementations, probability distributions may be calculated based on the domain data and the information in the second layer 304, in systems with sufficiently large amounts of available computational resources, which may provide a more robust decision optimization system.

As explained above, one or more benefits may be achieved through the use of a multi-layer probabilistic knowledge graph (e.g., the multi-layer probabilistic knowledge graph 300 of FIG. 3) as a digital twin of a real world component. For example, the multi-layer probabilistic knowledge graph 300 may provide improved querying as compared to digital twins that only incorporate a single layer model or that incorporate multiple individual models. To illustrate, a query may be executed against the multi-layer probabilistic knowledge graph 300 such that the query concurrently accesses multiple layers (e.g., the first layer 302 and the second layer 304, the second layer 304 and the third layer 306, the first layer 302 and the third layer 306, or the three layers 302-306) of the multi-layer probabilistic knowledge graph 300 to retrieve query results. Because the multi-layer probabilistic knowledge graph 300 represents multiple types of information (e.g., semantic knowledge, probabilistic data, decision data, etc.), a single query that includes elements corresponding to multiple types of information may be executed against the multi-layer probabilistic knowledge graph 300 retrieve results that include multiple different types of information, thereby providing more robust and useful results to a user. Additionally, concurrently accessing multiple layers of the multi-layer probabilistic knowledge graph 300 to retrieve the query results may be faster than querying multiple different independent models and may provide more unified and integrated, and thus more meaningful, results without additional aggregation or processing.

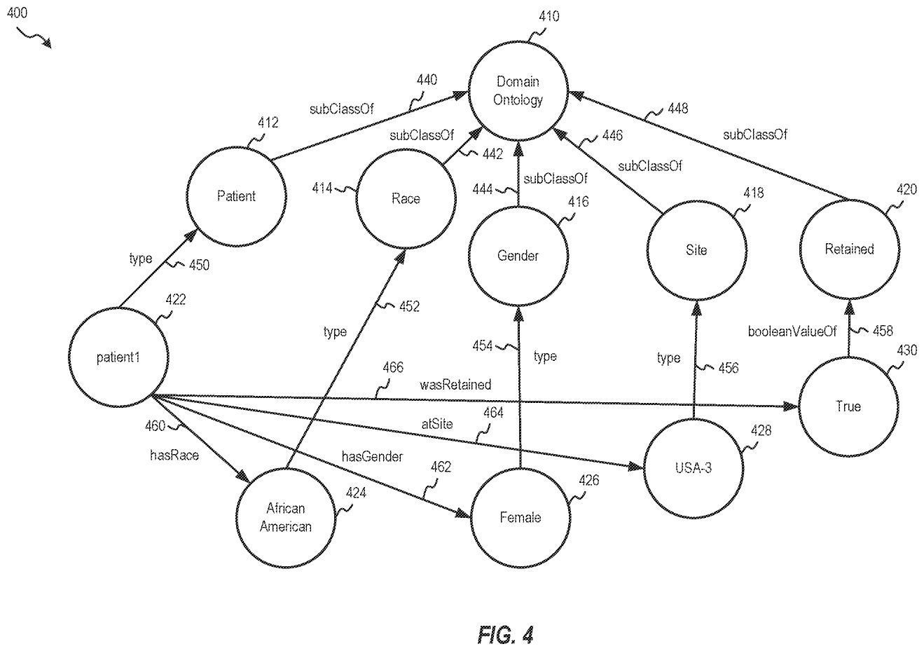

Referring to FIG. 4 a domain ontology knowledge graph according to one or more aspects of the present disclosure is shown as a domain ontology knowledge graph 400. The domain ontology knowledge graph 400 may provide a semantic representation of a real world counterpart represented by a digital twin, and the domain ontology knowledge graph 400 may be included as one layer of a multi-layer probabilistic knowledge graph used to create a digital twin. In some implementations, the domain ontology knowledge graph 400 may include or correspond to the first layer of the multi-layer probabilistic knowledge graph 112 of FIG. 1 and/or the first layer 302 of the multi-layer probabilistic knowledge graph 300 of FIG. 3.

The example illustrated in FIG. 4 provides a visualization of a domain ontology in the exemplary use case of a patient healthcare records domain, however, in other implementations, the domain ontology knowledge graph 400 may represent a different domain, such as a robot, a manufacturing facility, a computer system, a process, or the like. In the example shown in FIG. 4, the domain ontology knowledge graph 400 includes nodes 410-430 and edges 440-458 connecting pairs of the nodes 410-430. The nodes include a domain ontology node 410 (e.g., a patient healthcare record domain), domain ontology class nodes 412-420 that represent classes of the patient healthcare record domain, and instance nodes 422-430 that represent instances of the domain ontology classes. In the illustrated example, the domain ontology class nodes include a patient class node 412, a race class node 414, a gender class node 416, a site class node 418, and a retained class node 420, and the instance nodes include a patient instance node 422 (“patient1”), a race instance node 424 (“African American”), a gender instance node 426 (“Female”), a site instance node 428 (“USA-3”), and a retained instance node 430 (“True”). The edges 440-458 indicate semantic relationships between the classes of the corresponding pairs of nodes that the edges connect. For example, in FIG. 4, the edge 440 pointing from the patient class node 412 to the domain ontology node 410 indicates a semantic relationship between the nodes 410, 412, namely, that the ontology class patient represented by the patient class node 412 is included in or indicated by the patient record represented by the domain ontology node 410, as indicated by the label “subClassOf”, and therefore patient is a subclass of the patient record (e.g., patient name or identifier is a field of a patient record). It is noted that the edges of the domain ontology knowledge graph 400 may be defined such that they point from one node to another node (e.g., from node 410 to node 412) or from a node to data, and the particular node an edge points to may be determined based on the semantic relationship information included in the ontology (e.g., the ontology 160 of FIG. 1).

Similarly, the edge 442 pointing from the race class node 414 to the domain ontology node 410 indicates that race is a subclass of the patient record, the edge 444 pointing from the gender class node 416 to the domain ontology node 410 indicates that gender is a subclass of the patient record, the edge 446 pointing from the site class node 418 to the domain ontology node 410 indicates that site (e.g., treatment site) is a subclass of the patient record, and the edge 448 pointing from the retained class node 420 to the domain ontology node 410 indicates that retained (e.g., a retained status or discharged status) is a subclass of the patient record. As another example, the edge 450 pointing from the patient instance node 422 to the patient class node 412 indicates that the specific patient (“patient1”) represented by the patient instance node 422 is an instance (e.g., type) of the patient class, as indicated by the label “type.” Similarly, the edge 452 pointing from the race instance node 424 to the race class node 414 indicates that the specific race (“African American”) is an instance of the race class, the edge 454 pointing from the gender instance node 426 to the gender class node 416 indicates that the specific gender (“Female”) is an instance of the gender class, the edge 456 pointing from the site instance node 428 to the site class node 418 indicates that the specific site (“USA-3”) is an instance of the site class, and the edge 458 pointing from the retained instance node 430 to the retained class node 420 indicates that the retained status has a Boolean value of true, as indicated by the label “boolean ValueOf”. As additional examples, the edge 460 pointing from the patient instance node 422 to the race instance node 424 indicates that the specific instance of the race class represented by the race instance node 424 is an attribute of the specific patient represented by the patient instance node 422, as indicated by the label “hasRace”, the edge 462 pointing from the patient instance node 422 to the gender instance node 426 indicates that the specific instance of the gender class represented by the gender instance node 426 is an attribute of the specific patient represented by the patient instance node 422, as indicated by the label “hasGender”, the edge 464 pointing from the patient instance node 422 to the site instance node 428 indicates that the specific instance of the site class represented by the site instance node 428 is an attribute of the specific patient represented by the patient instance node 422, as indicated by the label “atSite”, and the edge 466 pointing from the patient instance node 422 to the retained instance node 430 indicates that the specific instance of the retained class represented by the retained instance node 430 is an attribute of the specific patient represented by the patient instance node 422, as indicated by the label “wasRetained”. It will therefore be appreciated that the domain ontology knowledge graph 400 of FIG. 4 represents the semantic knowledge and relationships that a specific patient (patient1) has various attributes, including a gender (Female), a race (African American), a specific treatment site (USA-3), and a Boolean value about whether they were retained in a past study. Each of these data instances are linked by corresponding edges to the appropriate ontology class, as well as being linked by corresponding edges to the patient instance to represent the attribute relationships.

Referring to FIG. 5, a diagram of an example of a probabilistic ontology graph model according to one or more aspects of the present disclosure is shown as a probabilistic ontology graph model 500. The probabilistic ontology graph model 500 may provide probabilistic relationships based on an underlying domain ontology, and the probabilistic ontology graph model 500 may be included as one layer of a multi-layer probabilistic knowledge graph used to create a digital twin In some implementations, the probabilistic ontology graph model 500 may include or correspond to the second layer of the multi-layer probabilistic knowledge graph 112 of FIG. 1 and/or the second layer 304 of the multi-layer probabilistic knowledge graph 300 of FIG. 3.

The example illustrated in FIG. 5 provides a visualization of a probabilistic ontology at a general level. In the example shown in FIG. 5, the probabilistic ontology graph model 500 includes nodes 510-520 and edges 530-540 connecting pairs of the nodes 510-520. The nodes include a domain ontology node 510, random variable nodes 512, 514 that represent random variables created from domain ontology classes, dependency node 516 that represents a Bayesian (e.g., probabilistic) dependency linking the random variable nodes 512, 514 and a probability distribution node 518 and a likelihood function node 520 that represent that the dependency represented by dependency node 516 has a probability distribution (e.g., a posterior distribution) and a likelihood function, respectively. The edges 530-540 indicate relationships between the elements represented by the corresponding pairs of nodes that the edges connect. For example, in FIG. 5, the edge 530 pointing from the random variable node 512 to the domain ontology node 510 indicates a semantic relationship between the nodes 510, 512, namely, that the random variable represented by the random variable node 512 (“Random Variable A”) is derived from a domain ontology class included in or indicated by the patient record represented by the domain ontology node 510, as indicated by the label “subClassOf”, and similarly the edge 532 pointing from the random variable node 514 to the domain ontology node 510 indicates that the random variable represented by the random variable node 514 (“Random Variable B”) is derived from a domain ontology class included in or indicated by the patient record represented by the domain ontology node 510. As another example, the edge 534 pointing from the dependency node 516 to the random variable node 512 with the label “hasSource” and the edge 536 pointing from the dependency node 516 to the random variable node 514 with the label “hasTarget” indicate that a dependency represented by the dependency node 516 has been instantiated between the two random variables such that Random Variable A is conditionally distributed given Random Variable B. This may be determined based on sampling the data received with the ontology (e.g., the domain data 162 of FIG. 1). As additional examples, the edge 538 pointing from the dependency node 516 to the probability distribution node 518 indicates a probability distribution for the dependency between Random Variable A and Random Variable B, as indicated by the label “hasDistribution”, and the edge 540 pointing from the dependency node 516 to the likelihood function node 520 indicates a likelihood function that describes a mathematical relationship between Random Variable A and Random Variable B, as indicated by the label “hasLikelihood”. In some implementations, the likelihood function is selected from among a predesignated functional family, such as polynomial functions, linear functions, etc.

Based on the healthcare domain example described with reference to FIG. 4, each domain ontology class in the domain ontology knowledge graph 400 may be mapped to a random variable to construct a Bayesian network based on the relationships in the data. To construct the Bayesian network in this manner, as a first step, an index ontology class whose instances can link instances of other classes is identified, similar to how a primary key in a relational database links rows in various tables. In this example, the system automatically selects Patient as the index ontology class, since its values are unique and not meaningful outside of the dataset (e.g., patient names such as patient1, patient2, etc.). Next, instances of the other classes may be paired to create conditional distributions. For example, it may be determined from FIG. 4 that the instances “Female” and “African American”, corresponding to the gender instance node 426 and the race instance node 424, respectively, are paired together because both instance nodes are connected to the patient instance node 422 (patient1). In this manner, a Bayesian network (e.g., a probabilistic ontology graph model) may be automatically constructed based on the domain ontology property structure indicated by the domain ontology knowledge graph 400. In the example of FIG. 5, both “Patient” and “Gender” are assigned a corresponding random variable node of the random variable nodes 512, 514, and a dependency relationship is automatically created between them by the dependency node 516, because instances of these classes are linked via a domain ontology property in the domain ontology knowledge graph 400 of FIG. 4. Learning the structure of Bayesian networks from scratch is typically an NP-Hard problem, and building a Bayesian network based on domain ontology properties may be a useful technique for approximating a true structure of the probabilistic ontology. In some implementations, direction of the Bayesian dependency relationships are set the same as the direction of the corresponding domain ontology property, even though the direction of the domain ontology properties may be arbitrary (e.g., inverse relationships such as “part of” and “has part” may be used interchangeably if the direction of the relationship is reversed). Alternatively, the direction of the domain ontology property may be analyzed and automatically corrected if determined to be better representative in the opposite direction.

In some implementations, the system may display the resultant Bayesian network (e.g., the probabilistic ontology graph model 500) to a user to enable the user to add additional random variables and/or dependencies in the Bayesian network that are not present in the domain ontology, or to modify existing random variables and/or dependencies. For example, the system may, via API(s) or GUI(s), solicit user input that specifies additional links and/or random variables to add to the Bayesian network. Additionally or alternatively, the system may support or provide other computational tools to enable the user to calculate additional dependencies and then provide them via user input for addition to the probabilistic ontology graph model 500. In some such implementations, the system may automatically calculate one or more suggested distributions and present them to the user for input whether to add them to the probabilistic ontology graph model 500.

Referring to FIG. 6, a diagram of an example of a decision optimization model according to one or more aspects of the present disclosure is shown as a decision optimization model 600. The decision optimization model 600 may provide decision information to optimize variable(s) (or achieve a target result or criterion) of an underlying probabilistic ontology graph model, and the decision optimization model 600 may be included as one layer of a multi-layer probabilistic knowledge graph used to create a digital twin In some implementations, the decision optimization model 600 may include or correspond to the third layer of the multi-layer probabilistic knowledge graph 112 of FIG. 1 and/or the third layer 306 of the multi-layer probabilistic knowledge graph 300 of FIG. 3.

The example illustrated in FIG. 6 provides a visualization of how the domain ontology knowledge graph 400 of FIG. 4 and the probabilistic ontology graph model 500 of FIG. 5, in the exemplary use case of a patient healthcare records domain, may be used to perform decisions based on an optimization corresponding to selecting a hospital site (e.g., treatment site) with a target racial distribution of patients. In the example shown in FIG. 6, the decision optimization model 600 includes nodes 610-628 and edges 630-656 connecting pairs of the nodes 610-628 and indicting the dependency relationships between the pairs of nodes. In this example, the domain ontology represents a database of patient records with an optimization problem of selecting a treatment site based on maximizing a projected retention rate for a particular race. The nodes 610-620 represent random variables that are also classes in the domain ontology knowledge graph 400, the node 622 represents a desired target which in this example is maximizing the retention rate variable, and the node 626 represents a utility function that is able to process a set of inputs and make a decision based on the target. Edges 630-638 represent the same domain ontology properties that are shown in FIG. 4 and that are part of the Bayesian network. In addition, additional Bayesian dependencies have been added between domain ontology classes where domain ontology properties do not exist in the domain ontology knowledge graph 400 or the probabilistic ontology graph model 500, which correspond to the edges 640-644.

Once the Bayesian network has been constructed, conditional distributions may be calculated based on sampling from the data. For each (source, target) pair of random variables linked via a dependency relationship, the domain ontology knowledge graph 400 may be traversed via the above-described patient index node to filter instances of the source by the target. For example, to calculate the conditional distribution of the site instance given the race instance, a dataset of the patient races treated at each site may be created. Each decision node may have a user-provided target which represents an ideal (e.g., optimized) state of the system, a set of dependent and independent variables over which to predict, and an outcome in the form of an entity in the decision optimization model 600 or a numeric value. In the example shown in FIG. 6, the node 624 represents the target and the node 628 represents the outcome.

An advantage of integrating the domain ontology, probabilistic ontology, and decision optimization model together in the same model (e.g., a multi-layer probabilistic knowledge graph) is that the system may traverse (e.g., access) multiple layers of the multi-layer probabilistic knowledge graph in a single query. This is convenient for asking questions that involve the probabilistic distributions of random variables, the decisions made based on the distributions, and/or the data itself. For example, an illustrative query may be created to answer the question: “For the hospital site that most closely matches the provided target distribution, what are the identifiers for the female patients from the most underrepresented racial group at this site?” As a non-limiting example, exemplary pseudocode for a query that answers this question is given below. In the pseudocode, the inner query searches a specific decision by its Uniform Resource Identifier (URI), then gets the most current distribution for the selected instance of the decision. The MINUS clause ensures that the selected distribution is the most up-to-date, as all other distributions will point to a more current distribution via a “precedes” relationship. Additionally, in the pseudocode, the combination of ORDER BY and LIMIT ensures that the raceLabel with the smallest probability concentration is returned to the outer query. The outer query uses this value to find female patients at the selected site of the given race.

PREFIX prob : <>
PREFIX dom : <>
Select * WHERE {
?patient a intient:Patient .
?patient intient:hasSiteIdentifier ?site .
?patient intient:hasGenderIdentifier intient:Female .
?patient intient:hasRacialIdentifier ?raceLabel .
{
SELECT ?raceLabel ?site WHERE {
intient:decision_RaceSiteDecision prob:hasDecisionResult
?site .
?genderRaceSiteDep a prob:Dependency .
?genderRaceSiteDep prob:dependencySource
intient:Race_Gender .
?genderRaceSiteDep prob:dependencyTarget intient:Site .
?genderRaceSiteDep prob:hasDistribution ?genderRace-
SiteDist .
?genderRaceSiteDist a prob:DirichletDistribution .
MINUS {
?genderRaceSiteDist prob:precedes ?otherDist .
}
?genderRaceSiteDist prob:hasDistributionGroup
?siteGroup .
?siteGroup a prob:DistributionGroup .
?siteGroup prob:isAbout ?site .
?siteGroup prob:hasDistributionCategory ?genderRaceCategory .
?genderRaceCategory a prob:DistributionCategory .
?genderRaceCategory prob:categoryLabel ?genderRaceLabel .
?genderRaceCategory prob:isAbout intient:Female .
?genderRaceCategory prob:isAbout ?raceLabel .
?raceLabel a intient:Race .
?genderRaceCategory prob:concentrationParameter ?conc .
}
ORDER BY ?conc
LIMIT 1
}
}

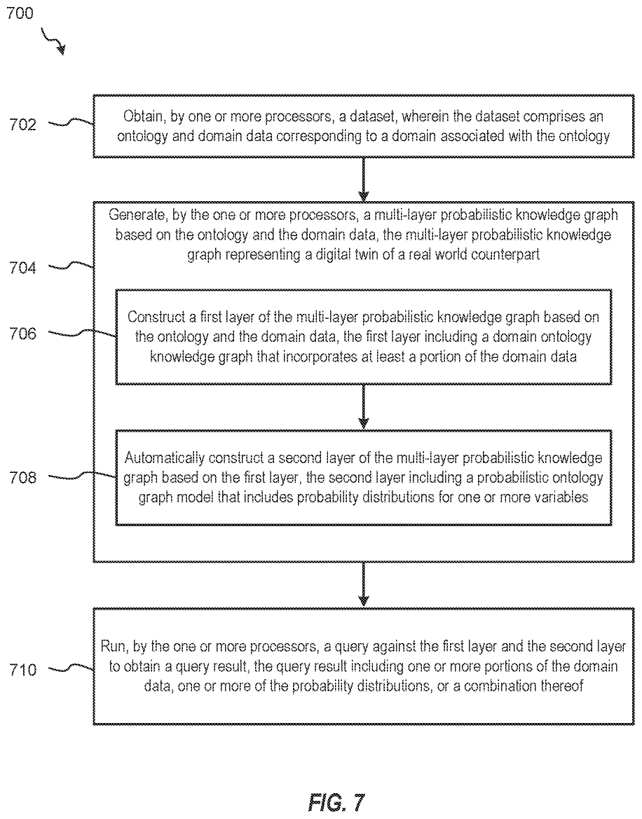

Referring to FIG. 7, a flow diagram of an example of a method for creating digital twins according to one or more aspects is shown as a method 700. In some implementations, the operations of the method 700 may be stored as instructions that, when executed by one or more processors (e.g., the one or more processors of a computing device or a server), cause the one or more processors to perform the operations of the method 700. In some implementations, these instructions may be stored on a non-transitory computer-readable storage medium. In some implementations, the method 700 may be performed by a computing device, such as the computing device 102 of FIG. 1 (e.g., a device configured for creating digital twins).

The method 700 includes obtaining a dataset, at 702. The dataset includes an ontology and domain data corresponding to a domain associated with the ontology. For example, the ontology may include or correspond to the ontology 160 of FIG. 1 and the domain data 162 may include or correspond to the domain data 162 of FIG. 1. The method 700 includes generating a multi-layer probabilistic knowledge graph based on the ontology and the domain data, at 704. The multi-layer probabilistic knowledge graph represents a digital twin of a real world counterpart. For example, the multi-layer probabilistic knowledge graph may include or correspond to the multi-layer probabilistic knowledge graph 112 of FIG. 1. In some implementations, the multi-layer probabilistic knowledge graph 112 represents a digital twin of the systems 154 of FIG. 1.

Generating the multi-layer probabilistic ontology graph includes constructing a first layer of the multi-layer probabilistic knowledge graph based on the ontology and the domain data, at 706. The first layer includes a domain ontology knowledge graph that incorporates at least a portion of the domain data. For example, the first layer may include a domain ontology knowledge graph generated by the knowledge engine 124 of FIG. 1. Generating the multi-layer probabilistic ontology graph also includes automatically constructing a second layer of the multi-layer probabilistic knowledge graph based on the first layer, at 708. The second layer includes a probabilistic ontology graph model that includes probability distributions for one or more variables. For example, the second layer may include a probabilistic ontology graph model generated by the probabilistic modelling engine 126 of FIG. 1. In some implementations, generating the multi-layer probabilistic ontology graph further includes constructing a third layer of the multi-layer probabilistic knowledge graph based on the probability distributions. The third layer includes a decision optimization model that represents decisions made based on an optimization of a set of variables from the probabilistic ontology graph model. For example, the third layer may include a decision optimization model generated by the optimization engine 128 of FIG. 1.

The method 700 includes running a query against the first layer and the second layer to obtain a query result. The query result includes one or more portions of the domain data, one or more of the probability distributions, or a combination thereof. For example, the query includes the query 114 of FIG. 1.

As described above, the method 700 generation of digital twins in an ontology-driven manner with less user input and that support improved querying capabilities as compared to other digital twins or individual information graph and probabilistic graph model-based technologies. For example, the method 700 enables a user to provide an ontology from which a first layer (e.g., a domain ontology knowledge graph) of a multi-layer probabilistic knowledge graph is generated. The method 700 also enables automatic generation, based on the domain ontology knowledge graph, of a second layer (e.g., a probabilistic ontology graph model) of the multi-layer probabilistic knowledge graph by mapping ontology domains to random variables and sampling domain data. This technique allows for quick conversion of domain knowledge into conditional probability distributions, which can be processed faster than the domain data itself. By storing the distributions as a layer on top of and integrated with the domain ontology knowledge graph, both layers can be accessed (e.g., traversed) simultaneously, enabling more flexible types of queries with better performance as compared to individually querying single models and aggregating the results.

It is noted that other types of devices and functionality may be provided according to aspects of the present disclosure and discussion of specific devices and functionality herein have been provided for purposes of illustration, rather than by way of limitation. It is noted that the operations of the method 700 of FIG. 7 may be performed in any order. It is also noted that the method 700 of FIG. 7 may also include other functionality or operations consistent with the description of the operations of the system 100 of FIG. 1.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for creating digital twins, the method comprising:
obtaining, by one or more processors, a dataset, wherein the dataset comprises an ontology and domain data corresponding to a domain associated with the ontology;
generating, by the one or more processors, a multi-layer probabilistic knowledge graph based on the ontology and the domain data, wherein the multi-layer probabilistic knowledge graph represents a digital twin of a real world counterpart, and wherein generating the multi-layer probabilistic knowledge graph includes:
constructing a first layer of the multi-layer probabilistic knowledge graph based on the ontology and the domain data, the first layer comprising a domain ontology knowledge graph that incorporates at least a portion of the domain data; and
automatically constructing a second layer of the multi-layer probabilistic knowledge graph based on the first layer, the second layer comprising a probabilistic ontology graph model that comprises probability distributions for one or more variables; and
running, by the one or more processors, a query against the first layer and the second layer to obtain a query result, the query result including one or more portions of the domain data, one or more of the probability distributions, or a combination thereof.

2. The method of claim 1, wherein generating the multi-layer probabilistic knowledge graph further includes:
constructing a third layer of the multi-layer probabilistic knowledge graph based on the probability distributions, the third layer comprising a decision optimization model that represents decisions made based on an optimization of a set of variables from the probabilistic ontology graph model.

3. The method of claim 2, wherein:
the query is run against the first layer, the second layer, and the third layer to obtain the query result; and
the query result further includes at least one of the decisions made based on the optimization of the set of variables.

4. The method of claim 2, wherein the decision optimization model includes one or more decision nodes that represent the decisions made based on the probability distributions, each decision node corresponding to:
a user-provided target that represents an ideal state of a system represented by the multi-layer probabilistic knowledge graph;
a set of dependent variables and independent variables over which to predict a decision; and
an outcome comprising an entity in the multi-layer probabilistic knowledge graph or a numeric value.

5. The method of claim 1, wherein the probabilistic ontology graph model comprises a plurality of nodes and edges connecting at least some of the plurality of nodes to one or more other nodes.

6. The method of claim 5, wherein:
the probability distributions correspond to random variables;
each of the random variables corresponds a node of the plurality of nodes; and
directed edges between nodes represent conditional dependencies between random variables corresponding to the nodes.

7. The method of claim 6, wherein the random variables are mapped to domain ontology classes of the domain ontology knowledge graph and relationships between classes of the domain ontology knowledge graph are mapped to dependencies between the random variables.

8. The method of claim 7, wherein each of the edges corresponds to a likelihood function and a probability distribution indicating a conditional probability of a target concept given a source concept.

9. The method of claim 8, further comprising:
automatically determining, by the one or more processors, likelihood functions and the probability distributions based on sampling the domain data.

10. The method of claim 1, wherein the domain ontology knowledge graph represents semantic relationships and the probabilistic ontology graph model represents statistical dependencies.

11. A system for creating digital twins, the system comprising:
a memory; and
one or more processors communicatively coupled to the memory, the one or more processors configured to:
obtain a dataset, wherein the dataset comprises an ontology and domain data corresponding to a domain associated with the ontology;
generate a multi-layer probabilistic knowledge graph based on the ontology and the domain data, wherein the multi-layer probabilistic knowledge graph represents a digital twin of a real world counterpart, and wherein to generate the multi-layer probabilistic knowledge graph the one or more processors are configured to:
construct a first layer of the multi-layer probabilistic knowledge graph based on the ontology and the domain data, the first layer comprising a domain ontology knowledge graph that incorporates at least a portion of the domain data; and
automatically construct a second layer of the multi-layer probabilistic knowledge graph based on the first layer, the second layer comprising a probabilistic ontology graph model that comprises probability distributions for one or more variables; and
run a query against the first layer and the second layer to obtain a query result, the query result including one or more portions of the domain data, one or more of the probability distributions, or a combination thereof.

12. The system of claim 11, wherein the one or more processors are further configured to:
provide an application programming interface (API) that provides query building functionality;
receive user input indicating one or more query parameters; and
generate the query based on the user input.

13. The system of claim 11, wherein the one or more processors are further configured to:
display a graphical user interface that includes the query result.

14. The system of claim 11, wherein the one or more processors are further configured to:
generate a control signal based on the query result; and
transmit the control signal to the real world counterpart.

15. The system of claim 11, wherein the real world counterpart is a machine, a workflow, a process, an entity or enterprise, or a combination thereof.

16. The system of claim 11, wherein, to generate the multi-layer probabilistic knowledge graph, the one or more processors are further configured to:
construct a third layer of the multi-layer probabilistic knowledge graph based on the probability distributions, the third layer comprising a decision optimization model that represents decisions made based on an optimization of a set of variables from the probabilistic ontology graph model.

17. A non-transitory computer-readable storage medium storing instructions that, when executed by one or more processors, cause the one or more processors to perform operations for creating digital twins, the operations comprising:
obtaining a dataset, wherein the dataset comprises an ontology and domain data corresponding to a domain associated with the ontology;
generating a multi-layer probabilistic knowledge graph based on the ontology and the domain data, wherein the multi-layer probabilistic knowledge graph represents a digital twin of a real world counterpart, and wherein generating the multi-layer probabilistic knowledge graph includes:
constructing a first layer of the multi-layer probabilistic knowledge graph based on the ontology and the domain data, the first layer comprising a domain ontology knowledge graph that incorporates at least a portion of the domain data; and
automatically constructing a second layer of the multi-layer probabilistic knowledge graph based on the first layer, the second layer comprising a probabilistic ontology graph model that comprises probability distributions for one or more variables; and
running a query against the first layer and the second layer to obtain a query result, the query result including one or more portions of the domain data, one or more of the probability distributions, or a combination thereof.

18. The non-transitory computer-readable storage medium of claim 17, wherein the probabilistic ontology graph model is automatically generated without user input defining random variables represented by the probabilistic ontology graph model or distributions between the random variables.

19. The non-transitory computer-readable storage medium of claim 17, wherein the probabilistic ontology graph model represents random variables and distributions between at least some of the random variables, the random variables corresponding to the probability distributions, and wherein the instructions further comprise:
receiving user input that indicates additional random variables, additional dependencies between random variables, or both; and
adding the additional random variables, the additional dependencies, or both, to the probabilistic ontology graph model.

20. The non-transitory computer-readable storage medium of claim 17, wherein the query indicates a variable to be optimized, and wherein generating the multi-layer probabilistic knowledge graph further includes:
constructing a third layer of the multi-layer probabilistic knowledge graph based on the probability distributions and the query, the third layer comprising a decision optimization model that represents decisions made based on an optimization of a set of variables from the probabilistic ontology graph model,
wherein the query is run against the first layer, the second layer, and the third layer to obtain the query result.
